(19) United States
(12) Patent Application Publication
(10) Pub. No.: US 2010/0241476 A1
(43) Pub. Date: Sep. 23, 2010

(54) Apparatuses, Methods and Systems For A Volunteer Sponsor Charity Nexus

(76) Inventors: Dudley Fitzpatrick, Pennington, NJ (US); Jason Alan Snyder, Philadelphia, PA (US)

Correspondence Address: CHADBOURNE & PARKE LLP, 30 ROCKEFELLER PLAZA, NEW YORK, NY, 10112, US

(21) Appl. No.: 12/376,105

(22) PCT Filed: Jul. 26, 2007
(86) PCT No.: PCT/US07/74519

§ 371 Date: May 5, 2010

Related U.S. Application Data
(60) Provisional application No. 60/820,578, filed on Jul. 27, 2006.
(60) Provisional application No. 60/827,054, filed on Sep. 26, 2006.
(60) Provisional application No. 60/827,056, filed on Sep. 26, 2006.

(51) Int. Cl. G06Q 50/00; G06Q 10/00

(52) U.S. Cl. 705/8; 705/329

(57) ABSTRACT

The present disclosure details apparatuses, systems and methods for providing a Volunteer Sponsor Charity Nexus. The Nexus enables volunteers, sponsors and charities to easily identify, connect, and coordinate with one another. The disclosed systems and methods collect profile data for volunteers, sponsors, and charities. The Nexus connects volunteers, sponsors, and charities, increasing the efficiency and effectiveness of charitable efforts.

### RELATED APPLICATIONS

This application claims all rights of priority under 35 U.S.C. §119 to provisional patent application No. 60/820,578 titled “APPARATUSES, METHOD AND SYSTEM FOR A VOLUNTEER SPONSOR CHARITY NEXUS,” and filed in the United States Patent and Trademark Office on Jul. 27, 2006. The entire contents of the aforementioned application is herein expressly incorporated by reference.

This application claims all rights of priority under 35 U.S.C. §119 to provisional patent application No. 60/827,054 titled “APPARATUSES, METHOD AND SYSTEM FOR A VOLUNTEER SPONSOR CHARITY NEXUS,” and filed in the United States Patent and Trademark Office on Sep. 26, 2006. The entire contents of the aforementioned application is herein expressly incorporated by reference.

This application claims all rights of priority under 35 U.S.C. §119 to provisional patent application No. 60/827,056 titled “APPARATUSES, METHOD AND SYSTEM FOR A VOLUNTEER SPONSOR CHARITY NEXUS,” and filed in the United States Patent and Trademark Office on Sep. 26, 2006. The entire contents of the aforementioned application is herein expressly incorporated by reference.

### FIELD

The present invention is generally directed to apparatuses, methods and systems for charity work, and more particularly, to apparatuses, methods and systems for connection and coordination of volunteers, sponsors, and charities

### BACKGROUND

Many charities exist, and specific charities can be found by searching the World Wide Web or phone directory listings. These methods provide information, such as the location of a particular charity, or perhaps a website operated by the charity. Currently, potential volunteers and sponsors identify individual charities on their own through manual self started research. Similarly, charities needing sponsors and/or volunteers manually post signs or other advertisements indicating that need.

### SUMMARY

This disclosure details the implementation of apparatuses, methods, and systems for a Volunteer Sponsor Charity Nexus (hereinafter “Nexus”). The Nexus enables volunteers, sponsors and charities to easily identify, connect, and coordinate with one another. Current methods provide only limited and static information, and significant additional manual and self started effort is required for volunteers, sponsors and charities to connect with one another. This additional effort lowers the participation in and the effectiveness of the charitable effort. The disclosed Nexus allows for specific criteria to be considered when matching volunteers, sponsors, and charities. Additionally, the Nexus allows any one of the volunteers, sponsors, or charities to search, identify and communicate with one or more complementary parties (volunteers, sponsors and/or charities) with which to work and cooperate. This fine-grained approach increases the efficiency of the connection and coordination processes, generates more cohesive and complementary cooperative sets of participants, and in doing so, increases both the satisfaction and effectiveness of the volunteers, sponsors and charities. Certain embodiments of the disclosed systems and methods utilize electronic networks, further increasing the efficiency of the connection and communication processes. Most importantly, the Nexus increases the effectiveness of charitable efforts, benefiting the entire community.

In one embodiment, a method is disclosed for providing coordination between volunteers, sponsors and charities. The method includes collecting and storing information about the involved parties (.e., volunteers, sponsors and charities), such as, for example, each party's charitable issue or issues. Additional information may be collected and stored for each of the parties, for example, a volunteer's availability (i.e., e and location available), a sponsor's level of support, and information on a charity's upcoming projects and activities (including time, location and support requirements). The collected and stored information is used to match and connect volunteers, sponsors and charities.

In another embodiment, a system is disclosed in which a Nexus connects volunteers, sponsors and charities. The Nexus collects and stores information from the involved parties (i.e., volunteers, sponsors and charities), such as, for example, each party's charitable issue or issues. The Nexus may collect and store additional information from the parties, such as volunteers' availabilities (time and location available), sponsors' levels of support, and information on charities' upcoming projects and activities (including time, location and support requirements). The Nexus may also collect information regarding the participants in particular projects or events. The Nexus uses the information to match and connect similar and complementary volunteers, sponsors and charities.

### BRIEF DESCRIPTION OF THE DRAWINGS

The accompanying appendices and/or drawings illustrate various non-limiting, representative, inventive aspects in accordance with the present disclosure:

FIG. 1A provides an overview of an embodiment of the Nexus;

FIG. 1B provides a schematic overview of an embodiment of the Nexus;

FIG. 2A provides a process flow for an embodiment of the Nexus;

FIG. 2B illustrates an example interface for an embodiment of the Nexus;

FIGS. 2C-2E shows example screenshots illustrating particular interface aspects of an implementation of the Nexus;

FIG. 3 provides an overview of a profile for an embodiment of the Nexus;

FIG. 4A shows an overview of an implementation of one embodiment of the Nexus;

FIG. 4B shows example search interface features for an embodiment of the Nexus;

FIGS. 4C-4H shows example screenshots illustrating particular interface aspects of an implementation of the Nexus;

FIG. 5A shows a screenshot for an example interface in one embodiment of the Nexus;

FIG. 5B-5D show example screenshots for web pages illustrating features of an activity creation interface in one embodiment of the Nexus;

FIG. 5E-5G show example screenshots for web pages illustrating features of an organization creation interface in one embodiment of the Nexus;

FIG. 5H-5I show example screenshots for web pages illustrating features of a cause creation interface in one embodiment of the Nexus;

FIG. 6A provides a schematic overview of another embodiment of the Nexus;

FIG. 6B provides a process flow overview of an implementation of the Nexus;

FIG. 6C provides an process flow overview for an example of a particular implementation of one embodiment of the Nexus;

FIG. 7A-7C provide schematic overviews of certain embodiments of the Nexus;

FIG. 8 provides a schematic overview of a further embodiment of the Nexus;

FIG. 9 illustrates a systemization diagram for an embodiment of the Nexus;

### DETAILED DESCRIPTION

A representative problem that can be solved by employing the Nexus is a charity's search for sponsors and volunteers. In a traditional quest for sponsors, the charity will search the yellow pages or search on the internet to find organizations or businesses. While each of these methods might identify some potential sponsors, the charity performing the search must still individually contact each of the potential sponsors identified to determine if the potential sponsor is interested in the charity's effort, and if so, what level of support the sponsor will provide.

In addition, the charity must conduct a separate search and recruitment effort to staff the project with volunteers qualified to work the project, typically by posting signs or placing advertisements indicating a need for volunteers. While these methods may inform some potential volunteers of the charity's effort, an interested potential volunteer must still contact the charity to determine if the schedule and location of the charity's effort is compatible with the volunteer's schedule and location. This required additional work and the general lack of a comprehensive structure hurts the efficacy of the volunteer outreach and recruitment efforts, and may put more pressure on the charity's existing volunteer pool, who must either devote more time and effort to volunteering or to finding additional volunteers. The lack of structure also damages the charity's ability to effectively communicate with their volunteers. Traditionally, communication with existing volunteers is infrequent, generally via phone or direct mail, and occurs only when there is need for help. Even when there is such a need, volunteers may get poor or incomplete directions, resulting in volunteers feeling resentful and frustrated.

Another representative problem that can be solved by the Nexus is a potential volunteer's search for a charity or charitable cause for which to volunteer and/or donate money and/or resources to. In such a situation, the potential volunteer will typically search their yellow pages or on the internet, ask friends or acquaintances, or perhaps see a notice or advertisement. While each of these solutions might identify some charities, the person performing the search must still contact each of the identified charities to determine if the charity's effort is of interest to the potential volunteer, and if so, whether the volunteers availability and location meets the schedule and location of the charity's effort. This problem is particularly pronounced when searching electronic sources, such as the internet, because the search will typically uncover numerous potential charitable entities. Contacting each of the charitable entities identified in the search and determining whether their efforts are appropriate and meet the potential volunteer's availability and geographic requirements would be tedious and time-consuming.

An additional representative problem that can solved by employing the Nexus is a potential sponsor's search for a charity to support. A potential sponsor may reach out to large, well-known charities or rely on charities to approach the potential sponsor. By focusing on well-known charities, the sponsor does not distinguish itself from other sponsors who also sponsor well known charities. Additionally, a sponsor using this method excludes new, small and/or local charities from consideration, and is thus has difficulty in growing or maintaining a positive reputation with specific groups, markets, and localities.

The effort required to connect volunteers, sponsors and charities is greatly reduced by providing apparatuses, systems and methods for a Volunteer Sponsor Charity Nexus (hereinafter “Nexus”). The Nexus allows volunteers, sponsors and charities to easily identify, connect, and coordinate with one another. The disclosed systems and methods are particularly useful when they are standardized such that relevant information from volunteers, sponsors and charities can be systematically collected, stored and processed. As described in detail below, the Nexus operates to connect and coordinate volunteers, sponsors and charities with similar, complementary and/or corresponding interests, schedules and locations. In some embodiments, additional inputs from volunteers, sponsors and/or charities are utilized in the connection and coordination process.

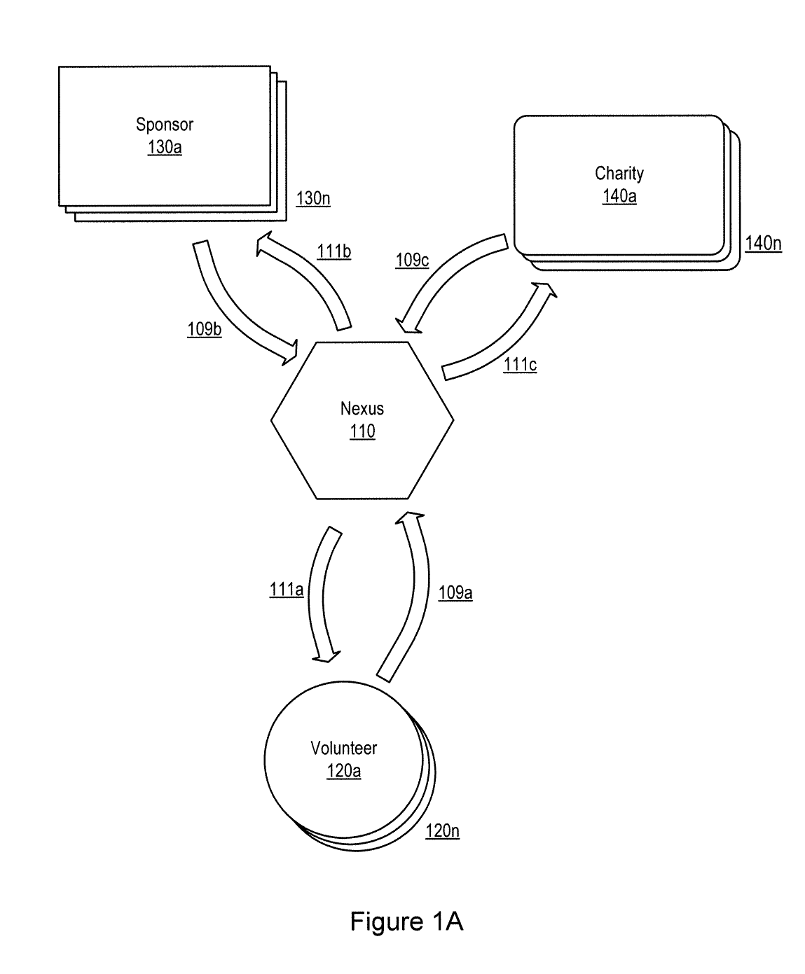

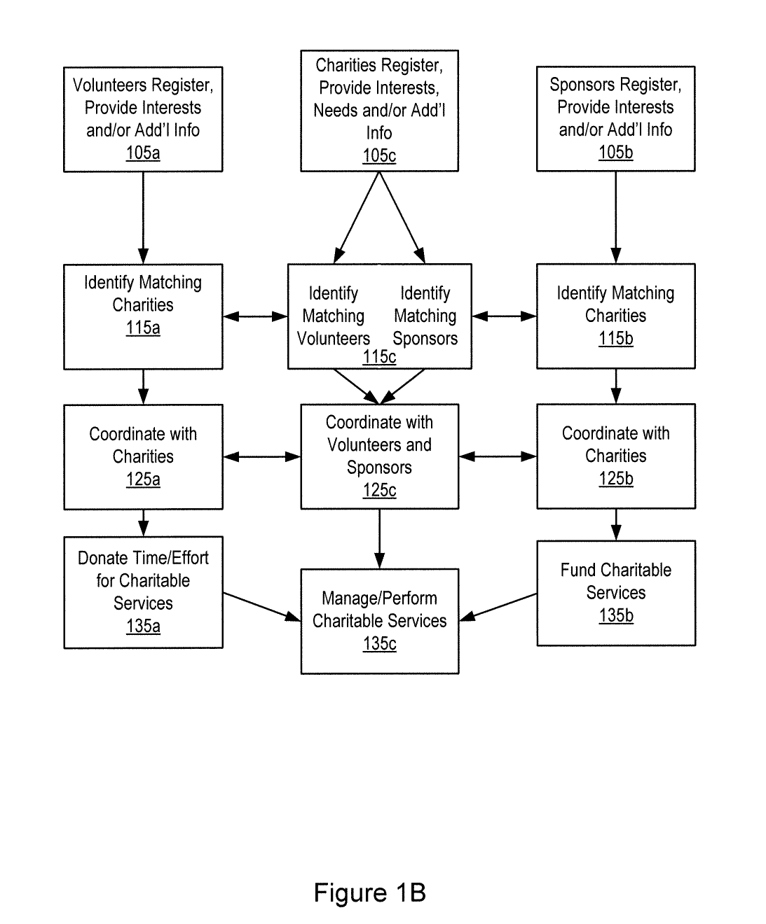

To that end, FIG. 1 shows an overview off the parties involved, volunteers 120a-120n, sponsors 130a-130n and charities 140a-140n, in an embodiment of the Nexus. The Nexus 110 may receive information 109a-109c from each of an arbitrary number of volunteers 120a-120n, sponsors 130a-130n and/or charities 140a-140n. In one embodiment, the information 109a-109c comprises a party's identifying information and associated charitable interest(s). In a further embodiment, the Nexus may also receive and store attribute information for each party. For example, attribute information for any party may include: location, schedule and/or availability. In certain embodiments, attribute information for volunteers' skills and/or abilities may also be received and stored, such as, by way of non-limiting example: construction and/or engineering experience, first aid training, legal training, and/or language abilities (i.e., foreign language or American Sign Language). In one embodiment, the Nexus may also receive attribute information on a charity's category of service, benefactors, need(s) and/or the like. In a further embodiment, the Nexus may collect additional information from any or all parties, including but not limited to information relevant to statistical, psychographic, demographic and marketing-related applications, for example consumer behavior information.

One example scenario might begin with a particular volunteer 120a contacting the Nexus 110 to communicate details about the volunteer's charitable interests, availability and skill set 109a. The volunteer, for example, might be a college student interested in donating coaching and mentoring services. When first contacting the Nexus, the volunteer would provide a detailed disclosure of interests, availability, skills, training/certification, and/or the like. The volunteer may have subsequent communications with the Nexus, for example, if the volunteer's details change (e.g., the volunteer's work schedule is no longer requires the volunteer to work weekends), the volunteer may communicate again with the Nexus to identify the new availability. The Nexus 110 stores the information provided by the volunteer 120a, along with comparable information supplied by other volunteers 120b-120n. Similarly, a sponsor 130a interested in donating to a certain cause, for example a national retailer interested in building a positive image within a particular community, would contact the Nexus 110 to communicate details about the sponsors charitable interests and requirements 109b.

Continuing with the above scenario, a particular charity 140a may contact the Nexus 110 to communicate 109c their need for volunteers 120b-120n. The charity might, for example, be starting a community basketball league, and need volunteer for coaching and officiating, as well as financial donations (i.e., sponsors 130a-130n). In one embodiment, after receiving the communication 109c from the charity 140a, the Nexus 110 algorithmically searches its stored records for volunteers 120a-120n and/or sponsors 130a-130n meeting the charity's identified needs. Upon identifying one or more appropriate matches, the matches are communicated 111c to the charity 140a. The Nexus 110 may also provide notifications 111a-111b to one or more of the matched volunteers 120a-120n and/or sponsors 130a-130n.

FIG. 1B provides a schematic overview of an embodiment of the Nexus in which volunteers 120a-120n, sponsors 130a-130n and/or charities 140a-140n interact with the Nexus 110 to register, indicate charitable interests and/or additional information 105a-105c, respectively, and identify complementary potential matches 115a-115c, respectively. The Nexus 110 enables the volunteers 120a-120n and charities 140a-140n to communicate and coordinate 125a, 125c. The Nexus 110 also enables the sponsors 130a-130n and charities 140a-140n to communicate and coordinate 125b, 125c, for example, using an electronic mailing list or internet forum. In a further embodiment, the Nexus allows the groups of volunteers, sponsors and charities to communicate and coordinate among themselves. The volunteers may then 120a-120n donate time and/or effort 135a and the sponsors 130a-130n provide funding 135b to the charities 140a-140n to perform the charitable services 135c. In certain embodiments, the sponsors 130a-130n receive acknowledgement for providing sponsorship 135b.

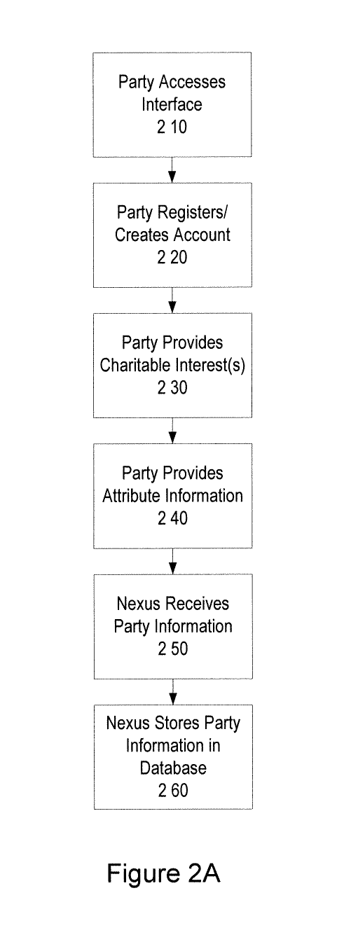

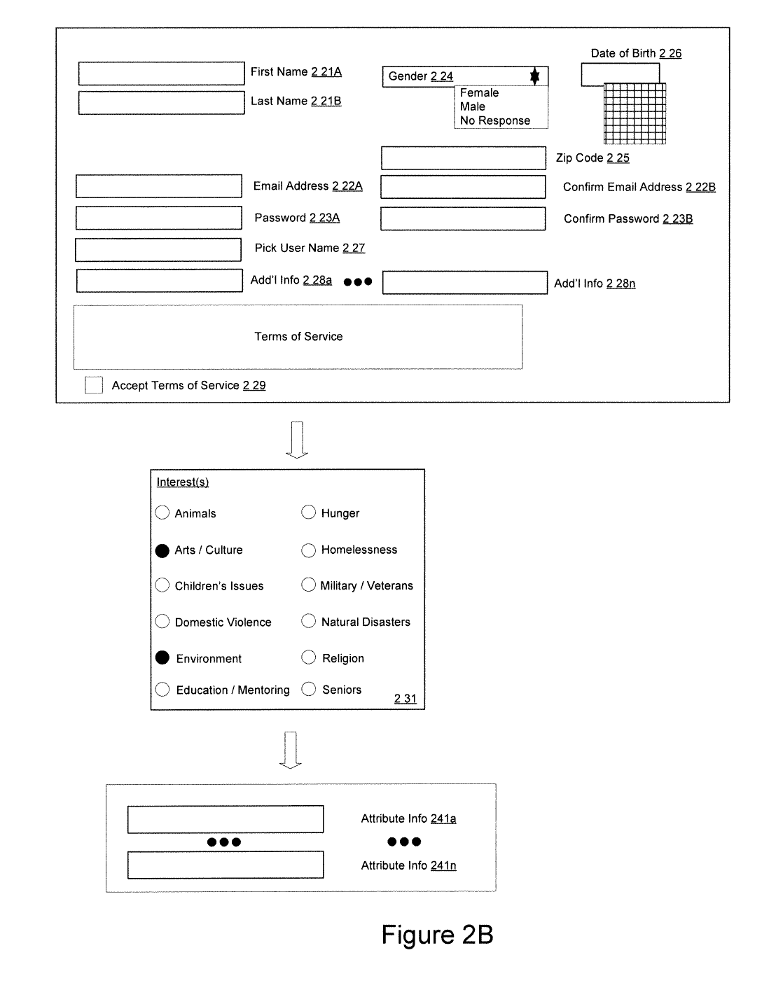

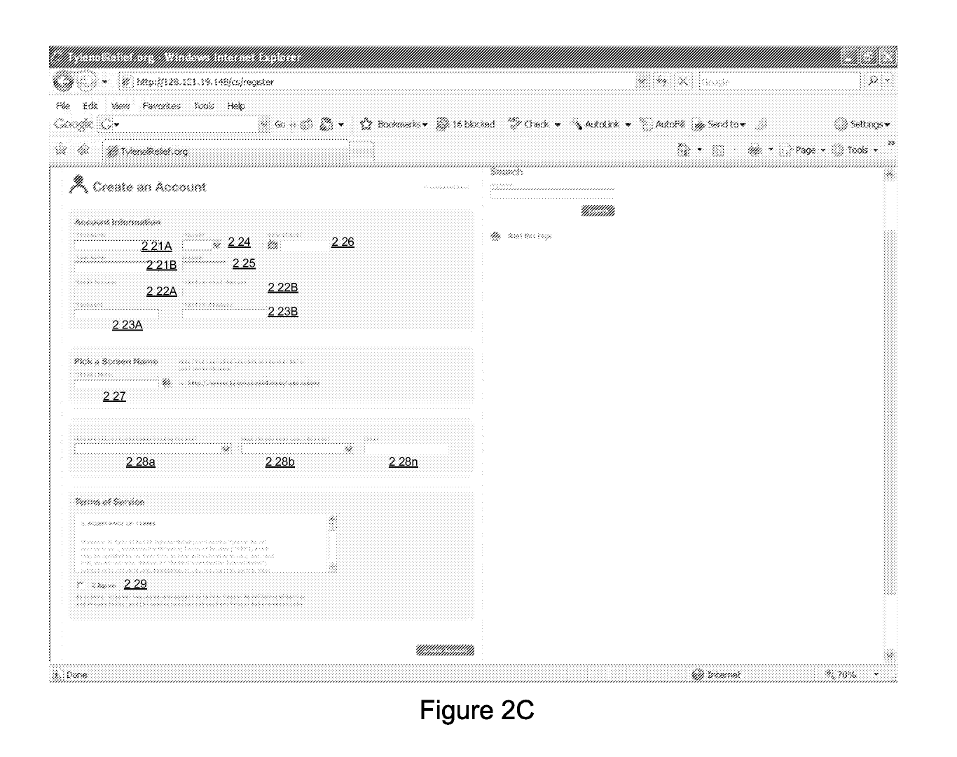

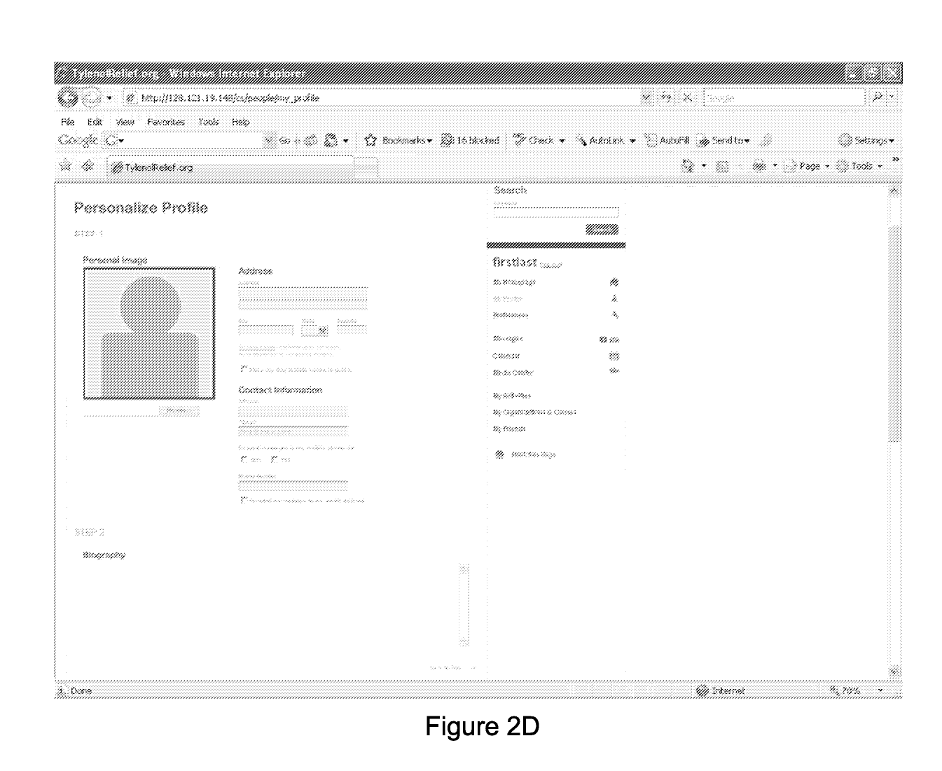

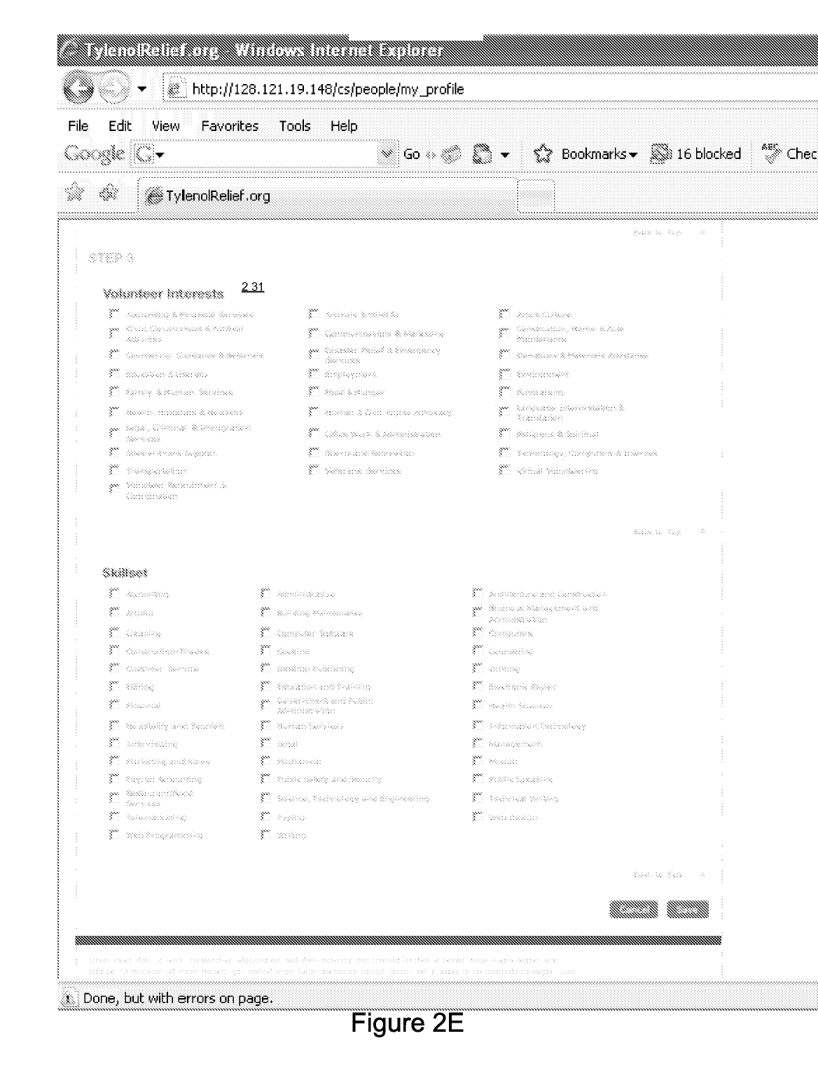

In one embodiment, the information 109a-109c is supplied to the Nexus when a party registers with and/or utilizes the services of the Nexus. For example, in one implementation, the Nexus provides an interface (e.g., a website) which allows volunteers 120a-120n, sponsors 130a-130n and/or charities 140a-140n to submit information 109a-109c to the Nexus 110 and interact with services provided by Nexus 110. For example, FIG. 2A provides a process flow for one embodiment of the Nexus in which a party accesses the interface 210 (e.g., navigates to the website) and registers/creates account 220. The party then provides charitable interest(s) 230 and attribute information 240, and the Nexus receives 250 the party's disclosed information and stores the information in a searchable database 260.

Table 1 below details example data elements that may be collected when a party registers/creates account 220 in one embodiment of the Nexus.

TABLE 1
Registration Data Elements

| | Form | Form | | | | | |
|---|---|---|---|---|---|---|---|
| | Input | Field | Database | Database | Database | | |
| Form Label | Type | Size | Name | Data Type | Field Size | Values | Required? |
| First Name | Text Box | 20 | fname | varchar | 40 | | Yes |
| Last Name | Text Box | 20 | lname | varchar | 40 | | Yes |
| Email Address | Text Box | 20 | email | varchar | 40 | | Yes |
| Confirm Email | Text Box | 20 | n/a | n/a | n/a | | Yes |
| Address | | | | | | | |
| Password | Password | 20 | pword | varchar | 20 | | Yes |
| Confirm | Password | 20 | n/a | n/a | n/a | | Yes |
| Password | | | | | | | |
| Gender | Drop | | gender | char | 1 | Please | Yes |
| | Down | | | | | Select, | |
| | Box | | | | | M or F | |
| Zip Code | Text Box | 10 | zip | varchar | 10 | | Yes |
| Screen Name | Text Box | 20 | sname | varchar | 20 | | Yes |
| How are you | Drop | | i_using | varchar | 20 | Multiple | No |
| most | Down | | | | | | |
| interested in | Box | | | | | | |
| using this site? | | | | | | | |
| How did you | Drop | | hear_about | varchar | 20 | Multiple | No |
| hear about this | Down | | | | | | |
| site? | Box | | | | | | |
| I Agree | Check | | a_terms | char | 1 | Y or | Yes |
| (Acceptance | Box | | | | | Null | |
| Terms) | | | | | | | |

Table 2 below details example data elements that may be collected when a party submits charitable interest(s) 230 and attribute information 240 in an embodiment of the Nexus.

TABLE 2
Charitable Interests and Attribute Data Elements

| | Form | Form | | | | | |
|---|---|---|---|---|---|---|---|
| | Input | Field | Database | Database | Database | | |
| Form Label | Type | Size | Name | Data Type | Field Size | Values | Required? |
| First Name | Text | 20 | fname | varchar | 40 | | Yes |
| | Box | | | | | | |
| Last Name | Text | 20 | lname | varchar | 40 | | Yes |
| | Box | | | | | | |
| Address | Text | 20 | address1 | varchar | 40 | | No |
| | Box | | | | | | |
| Address 2 | Text | 20 | address2 | varchar | 40 | | No |
| (label not | Box | | | | | | |
| displayed on | | | | | | | |
| form) | | | | | | | |
| City | Text | 20 | city | varchar | 40 | | No |
| | Box | | | | | | |
| State | Drop | | state | char | 2 | Please Select | No |
| | Down | | | | | (null in DB) | |
| | Box | | | | | and All 2 | |
| | | | | | | letter state | |
| | | | | | | codes | |
| Zip Code | Text | 10 | zip | varchar | 10 | | Yes |
| | Box | | | | | | |
| Make Public | Check | | m_public | char | 1 | Y or N | Yes |
| | Box | | | | | | |
| Email Address | Text | 20 | email | varchar | 40 | | Yes |
| | Box | | | | | | |
| Confirm | Text | 20 | n/a | n/a | n/a | | Yes |
| Email Address | Box | | | | | | |
| Phone | Text | 10 | phone | varchar | 10 | | Yes |
| Number | Box | | | | | | |
| Gender | Drop | | gender | char | 1 | Please Select | Yes |
| | Down | | | | | (null in DB), | |
| | Box | | | | | M or F | |
| Mobile Phone | Check | | phone_pref | char | 1 | SMS or TXT | No |
| Preference | Box | | | | | | |
| Mobile Phone | Text | 10 | m_phone | varchar | 10 | | Yes if SMS |
| Number | Box | | | | | | preference |
| | | | | | | | is chosen |
| Message | Text | 20 | m_email | varchar | 40 | | Yes if TXT |
| Email Address | Box | | | | | | preference |
| | | | | | | | is chosen |
| Biography | Text | | bio | varchar | 2048 | | No |
| | Area | | | | | | |
| Volunteer | Check | | v_interests | char | 2 | | No |
| Interests | Boxes | | | | | | |
| Skill Sets | Check | | skill_set | char | 2 | | No |
| | Box | | | | | | |
| Personal | File | | photo | varchar | 80 | (file | No |
| Photo | | | | | | reference) | |

FIG. 2B illustrates an example interface that one embodiment of the Nexus may provide to allow a party to register and provide additional information. The party may enter the appropriate information in the fields or text boxes provided for first name 221a, last name 221b, email address 222a, email address confirmation 222b, password 223a, password confirmation 223b, zip code 225, user name 227, and additional information 228a-228n. Drop down menus are provided for gender 224 and date of birth 226, along with a check box for accepting the terms of service 229. The party may then select the charitable issue(s) of interest 231 and provide additional attribute information 241a-241n.

FIGS. 2C-2E shows example screenshots illustrating particular interface aspects of an implementation of the Nexus. FIG. 2C shows an example account creation page for an implementation of the Nexus that a user may utilize to register with the Nexus. A user may enter the appropriate information in the fields or text boxes provided for first name 221a, last name 221b, email address 222a, email address confirmation 222b, password 223a, password confirmation 223b, zip code 225, and user name 227. Drop down menus are provided for gender 224, date of birth 226, the user's interest in using the site 228a and how the user heard about the site 228b, along with a check box for accepting the terms of service 229. FIGS. 2D and 2E show an example profile personalization page for an implementation of the Nexus that a user may utilize to provide the Nexus with additional information including charitable issue(s) of interest 231. The data fields shown in FIGS. 2B-2E interface are merely exemplary and other information could optionally be collected and various elements in FIGS. 2B-2E could be excluded. The interface elements shown are also merely exemplary and other suitable interface elements may alternatively be employed.

Profile

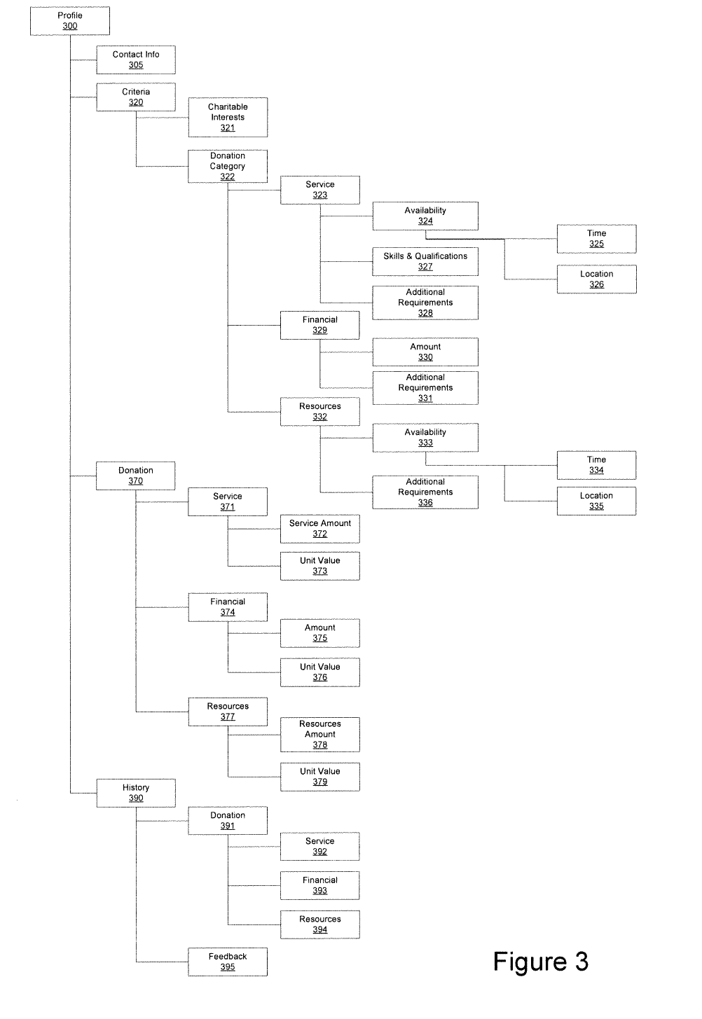

In one embodiment, the Nexus may use information (e.g., 109a-109c, 221a-229, 231, 241a-241b) received from each of the volunteers 120a-120n, sponsors 130a-130n and/or charities 140a-140n in generating a corresponding party profile. In some embodiments, the content of the profile generated by the Nexus is itself a novel data structure. FIG. 3 provides an overview of a profile for volunteers and/or sponsors in one embodiment of the Nexus. In some implementations, the profile 300 is uniquely specified by a party ID (e.g., the party user name entered in field 227), and may contain contact information 305 for the particular party, for example, address, phone number and/or email (e.g., field 222a) information. The profile may also have a criteria category 320 relating to the party's interests, including a party's general charitable interests information 321 (e.g., child advocacy, adult literacy, community health and so forth) and donation category information 322.

For service donation, the service donation information 323 may indicate the party's availability 324 to perform the service, including the time 325 and location 326 that the party is available. Service donation information may also contain the party's disclosed skills and qualifications 327 and any additional requirements 328 or stipulations indicated by the party. Financial donation information 329 may indicate the monetary amount(s) 330 a party is willing to provide along with any additional requirements 331 regarding the donation. In a further embodiment, a party may wish to donate access to or use of a resource, such as a meeting hall, campground, or truck. In such a situation, the resource donation information 332 may include the indicated resource's availability 333, including the time 334 and/or location 335 the resource is available, as well as additional information or requirements 336 regarding access to the resource.

In one embodiment, the profile contains an ‘actual donation’ category 370 with information on actual donations (service 371, financial 374, resources 377) with respective amounts (372, 375, 378) and unit values (373, 376, 379). In a further embodiment, the valuing, tracking and recording of donations of services 371, financing 374, and resources 377 is utilized to provide the volunteer and/or sponsor tax benefit information (i.e., a tax write-oft). For example, in the case of an attorney who donates legal services, the profile would reflect the amount of time 372 (e.g., 10 hours of service) and the unit value of the service 373 (e.g., $400/hour). For 10 hours of service donated (to one or multiple charitable efforts), the Nexus may generate documentation indicating the attorney made a charitable contribution of $4,000. In another implementation, the actual donations (service 371, financial 374, resources 377) could be provided to parties who are reviewing and selecting complementary parties, who may choose or bid for certain donations. For example, using the above example, the attorney could indicate that they were willing to donate a certain amount of time 372 and the unit value of that time 373, for example, 2 hours valued at $400 an hour. Charities in need of legal services could use such information, in addition to other profile information, to select appropriate matches, and in a further embodiment, bid on services and/or other donations.

A profile may also contain the party's historical information 390, including donation history details 391 and feedback 395. In one embodiment, feedback may include information from the party regarding previous donations (e.g., a volunteers positive experience donating time to a particular charitable effort). Alternatively, or additionally, the profile's feedback may contain information from other parties, for example, the feedback could include comments from a charity regarding the service the volunteer previously donated to the charity.

Profiles for charity's and/or charitable efforts may be similarly structured to the profile disclosed in FIG. 3, with similar and complementary categories as appropriate. For example, the profile for a charity or charitable interest may have the charity's charitable interests similar to the general charitable interest information 321 described above, but instead of having the time 325 and location 326 available, the charity profile would have the time and location of an activity or activities.

XML for a party profile in one embodiment of the Nexus may take the following form:

```
<Profile_ID> Joe1234
  <Contact_Info>
    Joe Young
    456 Middle Road, Kansas City, Kansas
    joe1234@mail.com
  </Contact_Info>
  <Criteria>
    <General_Interests> Community Education, Children's Issues
    </General_Interests>
    <Donation_Category>
      <Service> Teaching, Coaching
        <Serv_Availability>
          <Serv_Time>
            Saturday, 10AM - 5PM
            Sunday, 10AM - 5PM
          </Serv_Time>
          <Serv_Location> Kansas City Area
          </Serv_Location>
        </Serv_Availability>
        <Skills_Quals>
          Certified Life Guard
          ASL Proficiency
        </Skills_Quals>
        <Serv_Addl_Req> </Serv_Addl_Req>
      </Service>
      <Financial> N/A
        <Amount> </Amount>
        <Fin-Addl_Req> </Fin-Addl_Req>
      </Financial>
      <Resources> Pickup Truck - ‘95 Ford F-150
        <Res_Availability>
          <Res_Time>
            Sunday, 5PM - 8PM
          </Res_Time>
          <Res_Location> Kansas City Area
          </Res_Location>
        </Res_Availability>
        <Res_Addl_Req> “Not for towing trailers”
        </Res_Addl_Req>
      </Resources>
    </Donation_Category>
  </Criteria>
  <Actual_Donation>
    <Serv_Donation> Coaching
      <Serv_Amount> 10 hours </Serv_Amount>
      <Serv_Unit_Value> $20/hour </Serv_Unit_Value>
    </Serv_Donation>
    <Fin_Donation> N/A
      <Fin_Amount> </Fin_Amount>
      <Fin_Value> </Fin_Value>
    </Fin_Donation>
    <Res_Donation> N/A
      <Res_Amount> </Res_Amount>
      <Res_Unit_Value> </Res_Unit_Value>
    </Res_Donation>
  </Actual_Donation>
  <History>
    <Donation_History> 24 months
      <Serv_History>
        Kansas City Little League softball instructor
      </Serv_History>
      <Fin_History> </Fin_Histoty>
      <Res_History> </Res_History>
    </Donation_History>
    <Feedback>
      “Joe really helped our team - highly recommended! -
      Micah, KC Little League Center”
    </Feedback>
  </History>
</Profile_ID>
```

In this example, the profile indicates Joe Young lives in Kansas City, Kansas and is interested in community education and children's issues. He is interested in donating 10 hours of teaching and coaching services (valued at $20 an hour) on weekends between 10 AM and 5 PM in the Kansas City area. Joe is a certified lifeguard and is proficient in American Sign Language (ASL). Joe also has a history going back 24 months and previously a volunteer softball instructor for the Kansas City Little League Center, for which the profile indicates he has positive feedback. As noted above, most of these entries would have been populated in response to the volunteers interaction with the user interface presented when the volunteer registers/creates an account 220, provides charitable interest(s) 230, and attribute information 240. The Nexus may also provide additional interfaces and receive and store information from interactions with those interfaces to, for example, obtain feedback and history information.

Searching

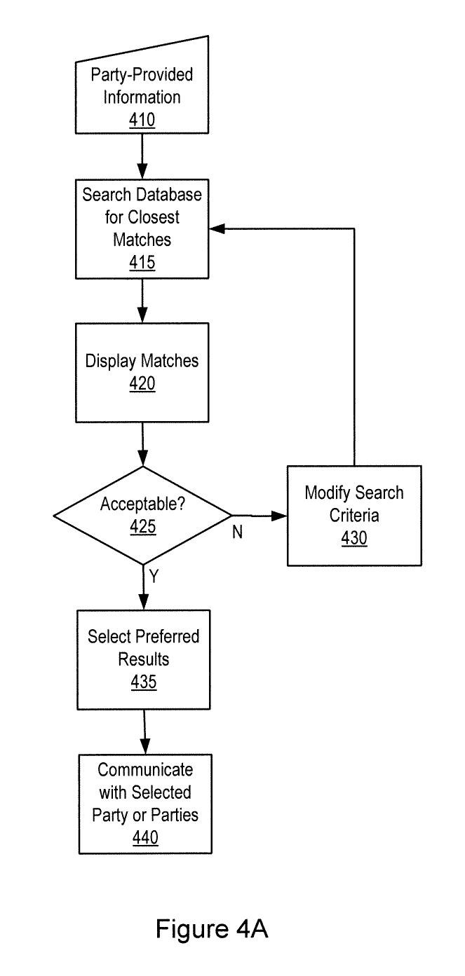

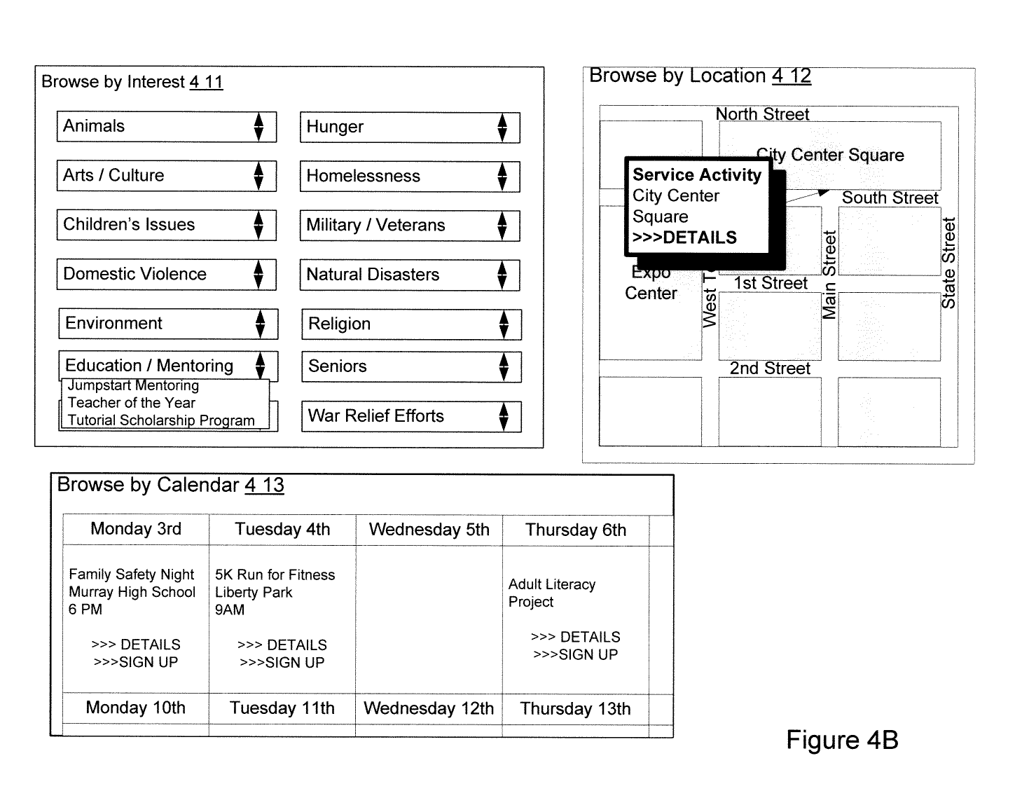

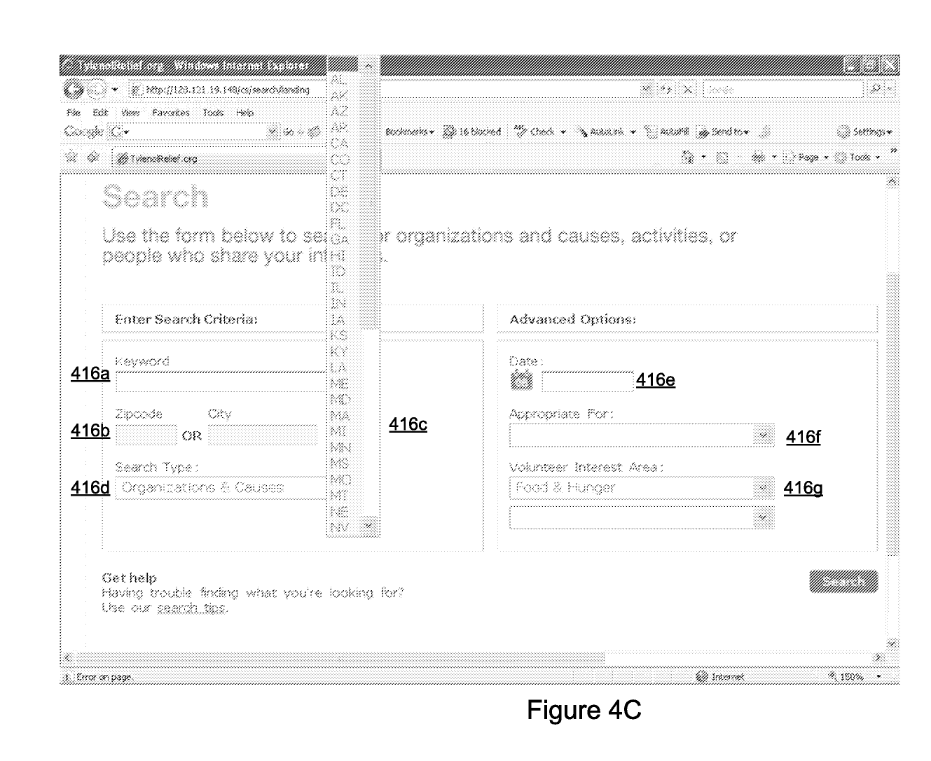

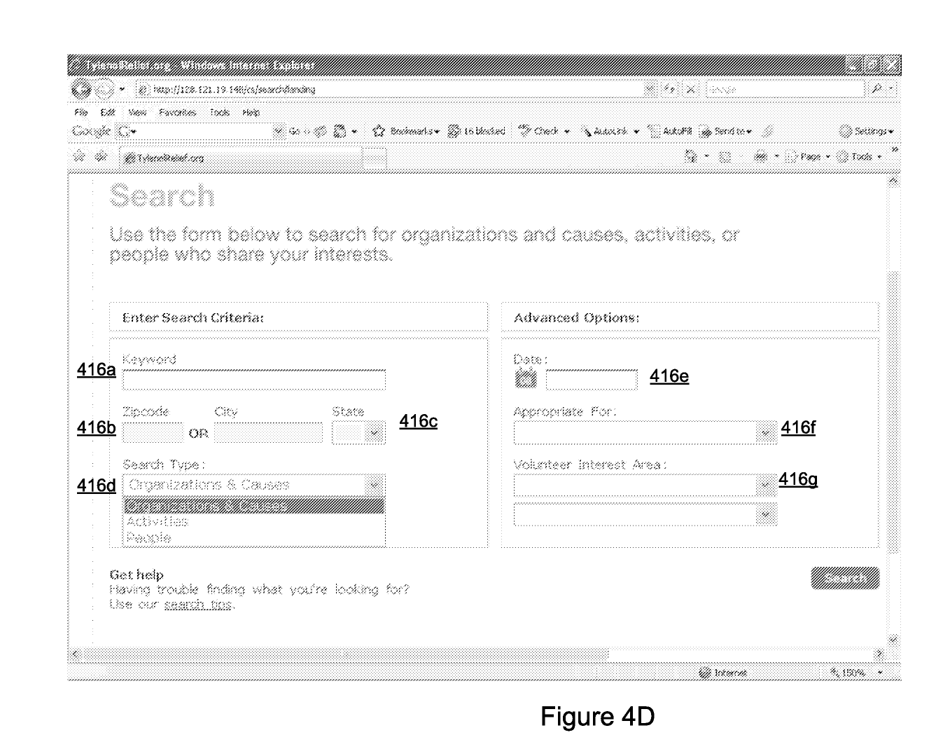

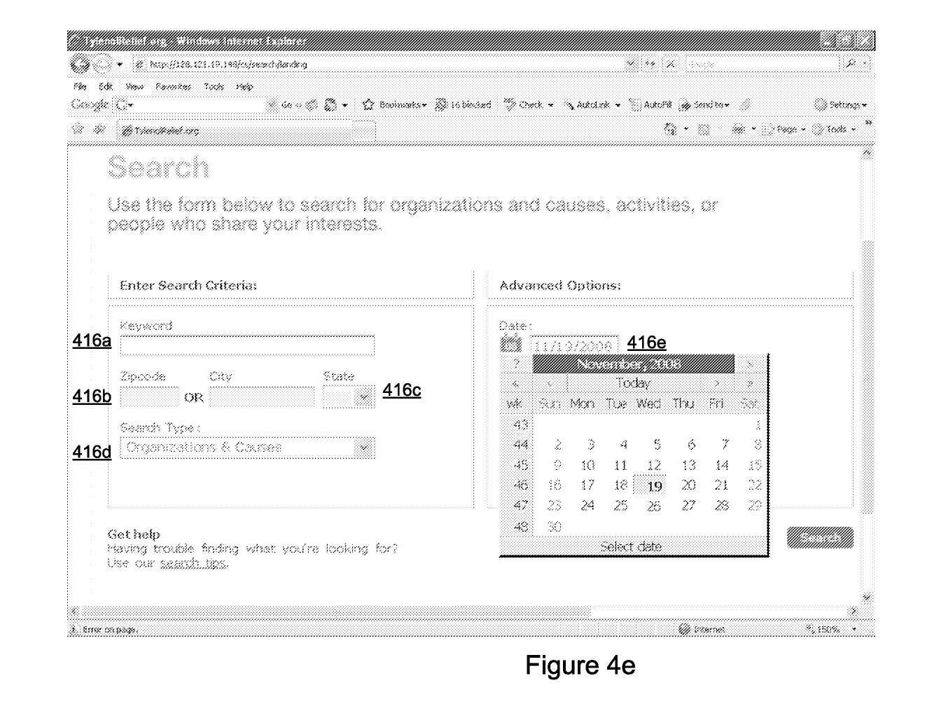

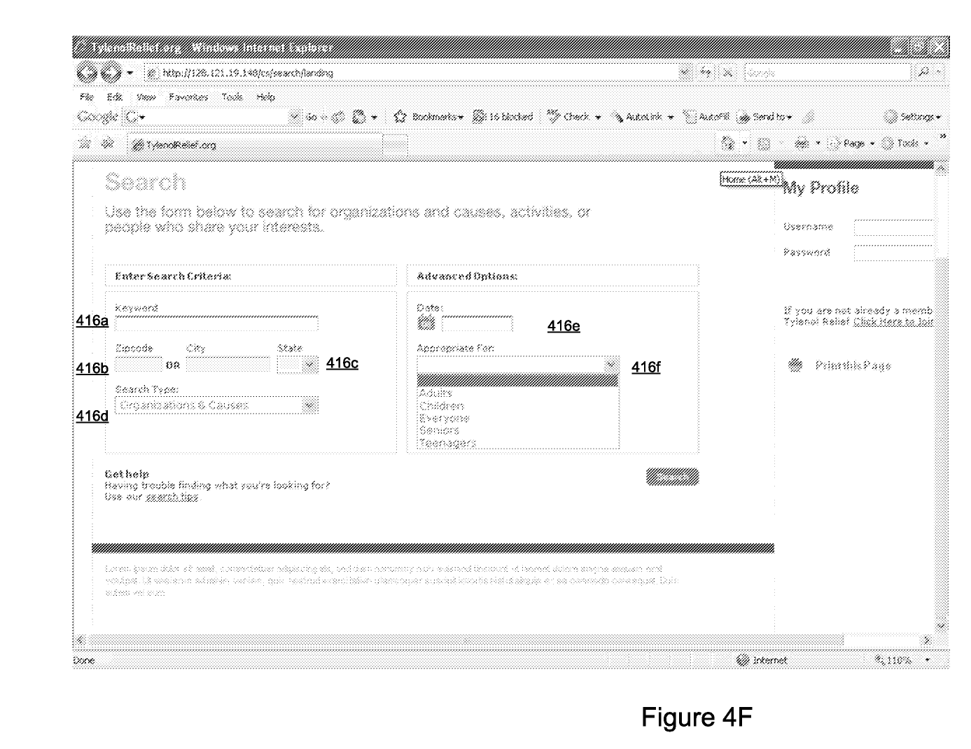

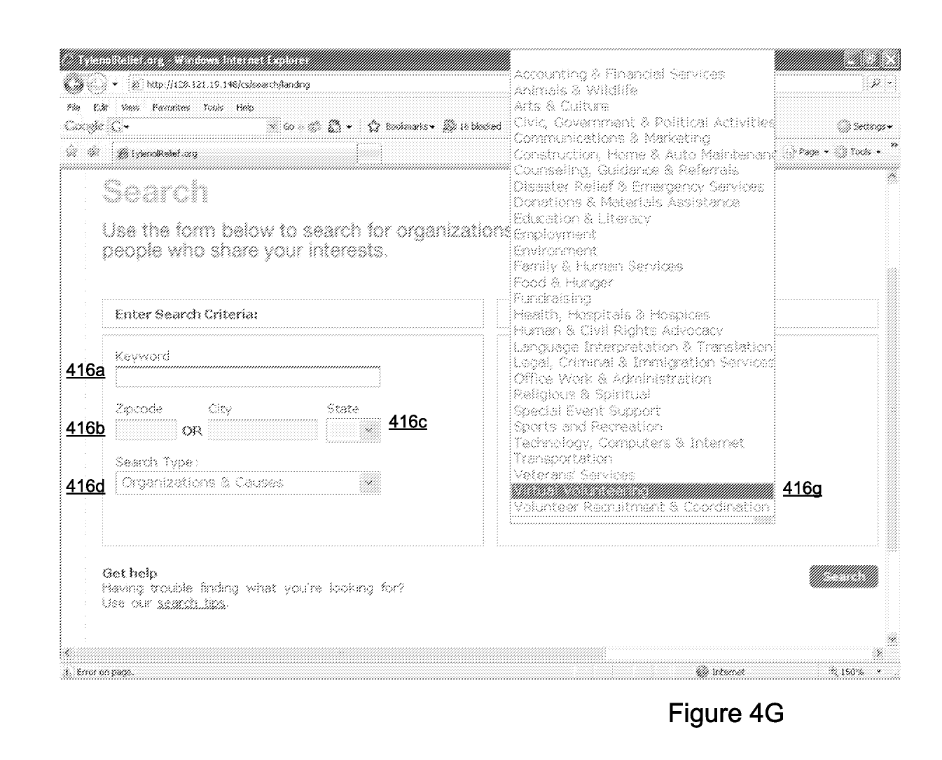

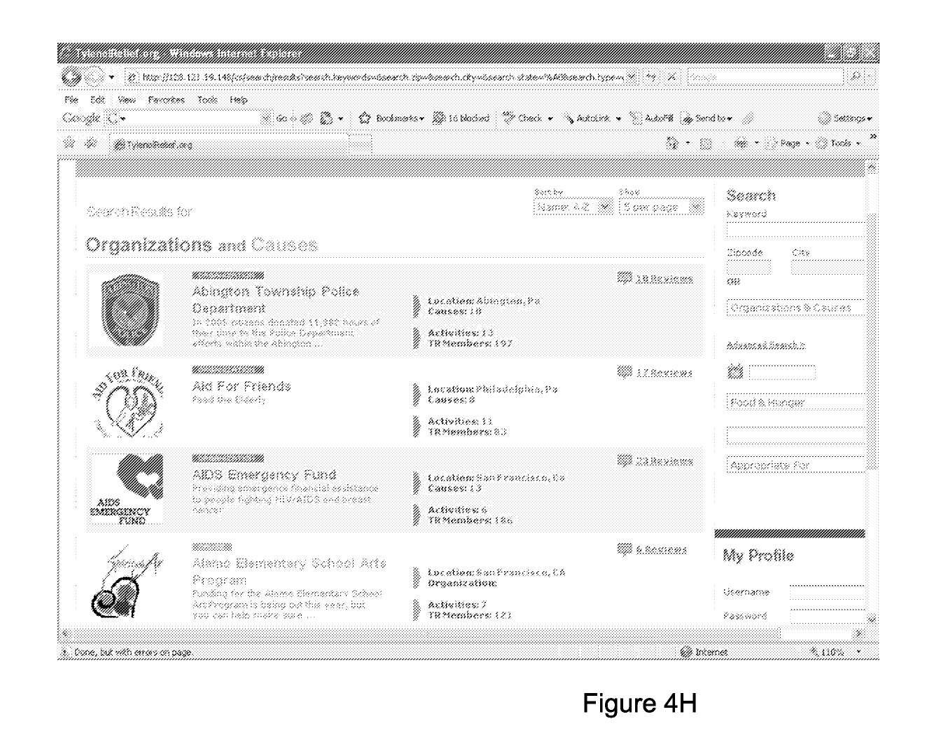

In one embodiment, the Nexus may allow users (generally parties) access to selected profiles and/or certain elements of the profiles via a searchable database, with search functions to identify potential matches. FIG. 4A shows an overview of an implementation of an embodiment of the Nexus in which the Nexus determines possible appropriate matches for a user (e.g., a volunteer, sponsor or charity) by receiving information provided by the user 410, such as the party profile information disclosed above and/or additional search terms or categories (described in greater detail below). The information is processed to generate queries used for searching the database for the closest matches 415. The closest matches are displayed to the user 420, who may determine is the results are acceptable 425. If the results are not acceptable (e.g., there are too many or not enough), the search criteria may be modified 430 and the search performed again 415, and the process iterated as necessary to find adequate matches. If the displayed matches are acceptable, the user may select the preferred results 435 and communicate with the selected party or parties 440, for example, using a contact email or phone number disclosed in a selected party's profile.

Table 3 below details example fields that may be provided on a search interface allowing a user to enter search terms in an embodiment of the Nexus.

TABLE 3
Search Data Elements

| | Form Input | Form Field | | Search | |
|---|---|---|---|---|---|
| Form Label | Type | Size | Values | Type | Required? |
| Keyword | Text Box | 20 | | Basic | No |
| Zip Code | Text Box | 10 | | Basic | No |
| City | Text Box | 20 | | Basic | No |
| State | Drop Down Box | 2 | Please Select | Basic | No |
| | | | and All 2 letter | | |
| | | | state codes | | |
| Groups | Drop Down Box | | Please Select, | Basic | No |
| | | | People, | | |
| | | | Organizations, | | |
| | | | Causes and | | |
| | | | Activities | | |
| Start Date - Month | Text Box | 2 | | Advanced | No |
| Start Date - Day | | 2 | | Advanced | |
| Start Date - Year | | 2 | | Advanced | |
| Category 1 | Drop Down Box | | Multiple | Advanced | No |
| Category 2 | Drop Down Box | | Multiple | Advanced | No |
| Appropriate For | Drop Down Box | 10 | Please Select, | Advanced | No |
| | | | Everyone, | | |
| | | | Children, | | |
| | | | Teenagers, | | |
| | | | Adults and | | |
| | | | Seniors | | |

FIG. 4B shows example search interface features for one embodiment of the Nexus that allows users to identify potential matches, by, for example, implementing these features on a web page. A charitable interest interface feature 411 allows users to select and browse by charitable interest(s), and a location interface feature 412 allows users to browse potential matches using a map. For example, a volunteer could use the location interface feature 412 to find charitable efforts and/or like-minded volunteers in a particular neighborhood. A calendar interface feature 413 could alternatively or additionally be provided to allow users to browse potential matches using a calendar.

FIGS. 4C-4G shows example screenshots illustrating particular interface aspects of an implementation of the Nexus. As shown in the figures, the disclosed interfaces allow a user to enter a keyword 416a for a text search. A user may enter a ZIP code 416b or enter a city and select a state 416c (FIG. 4C) from a drop down menu. A user may search by selecting a search type 416d (FIG. 4D) for organizations and causes, activities, or people. A user may also search by date 416e, for example, manually entering a date or by selecting a date from a drop down calendar (FIG. 4E). The search may also include criteria for age appropriateness 416f (FIG. 4F). For example, the age appropriateness search function 416f may be particularly important for high school service groups or retired volunteers looking for charitable projects for which to volunteer their time. Similarly, potential sponsor may find the feature useful in identifying activities that would have resonance with a certain category or grouping of volunteers. The disclosed interfaces also allow a user to select an interest area 416g (FIG. 4G) or areas for the search. Additional search functions may included, by way of non-limiting example: text, natural language, skills, abilities, proximity and promotions.

FIG. 4H provides an example screenshot of an embodiment of the Nexus illustrating what the interface displaying the closest matches 420 (as described above) for a search of organizations and causes. A user could refine the search, or select from the results to get additional details, including contact, event, and feedback information. The fields shown in the interfaces of FIGS. 4B-4H are merely exemplary. Other fields could optionally be incorporated and various elements in FIGS. 4B-4H could be excluded. In addition, the interface elements shown are also merely exemplary and other suitable interface elements could alternatively be employed.

Matching

In some embodiments, the Nexus determines appropriate matches and may automatically provide selected results to the appropriate individual volunteers, sponsors and/or charities. In one embodiment, the Nexus may analyze the stored profiles and identify volunteers, sponsors and charities with similar, complementary and/or appropriately corresponding profiles. Individual volunteers 120a-120n, sponsors 130a-130n and charities 140a-140n may be notified via communications 111a-111c, respectively, that the Nexus 110 has identified similar, complementary and/or appropriately corresponding profiles.

For example, in one embodiment, the Nexus may identify the profile of a volunteer who lives in Kansas City, is a trained life guard, is available to volunteer on weekends and is interested in community education and children's issues (i.e., the profile of Joe Young described above) as similar and/or appropriately corresponding with a profile for a Kansas City community center (a charity) that needs volunteer instructors for a Saturday youth swim class. Similarly, the Nexus would identify a profile for a sponsor that is interested in funding community education and development in the Kansas City area as complementary and/or appropriately corresponding to the profile for the Kansas City community center.

In a further embodiment, the analysis of the stored profiles by the Nexus additionally comprises assigning metrics corresponding to the provided information, wherein similar, complementary and/or appropriately corresponding profiles would have similar, complementary and/or appropriately corresponding metrics. In certain embodiments, the Nexus would use the metrics to further identify, group and/or associate the indicated profiles. The Nexus may also extract additional data from party profiles and parse said data by interest, geographic, demographic, and/or other criteria to yield party profiling information. Such information may be particularly useful to sponsors, such as corporations, who may want to reach a particular market demographic or community subgroup by working with particular charities and/or volunteers. In a further embodiment, the Nexus may provide access to party profiling information and associated profiles and/or certain elements of the profiles via a searchable database.

Homepage

In some embodiments, certain aspects of the identified profiles, such as contact information, may be communicated by the Nexus 110 to respective volunteers 120a-120n, sponsors 130a-138n and charities 140a-140n. In certain embodiments, the Nexus may facilitate the communication between volunteers and charities and/or sponsors and charities, for example, via electronic messaging or a web site. In another embodiment, the Nexus would identify profiles from the same group (i.e., volunteers, sponsors or charities) that are similar, complementary and/or appropriately corresponding, for example, identifying volunteers as substantially similar to one another if they have similar locations and charitable interests. Similarly, the Nexus may facilitate communication within groups, such as among volunteers with similar locations and interests.

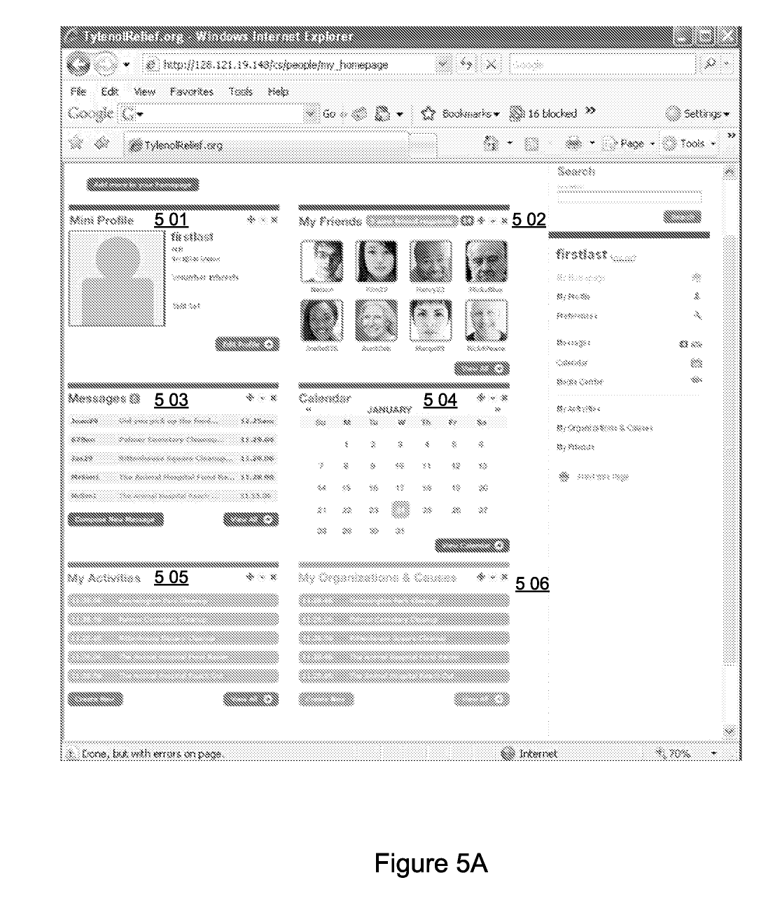

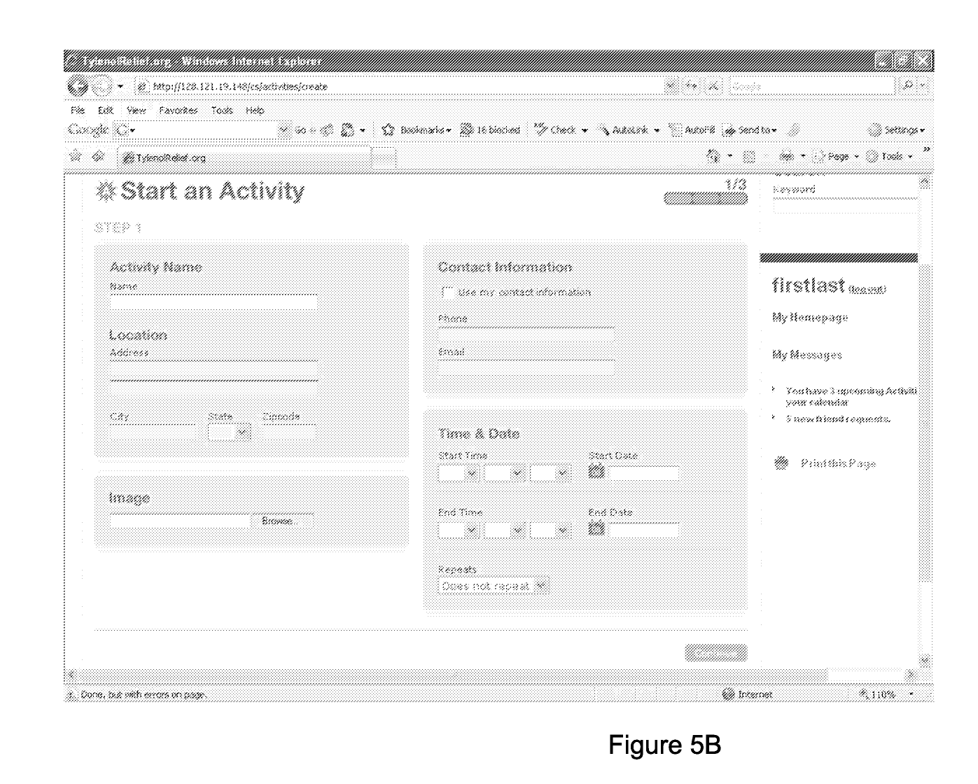

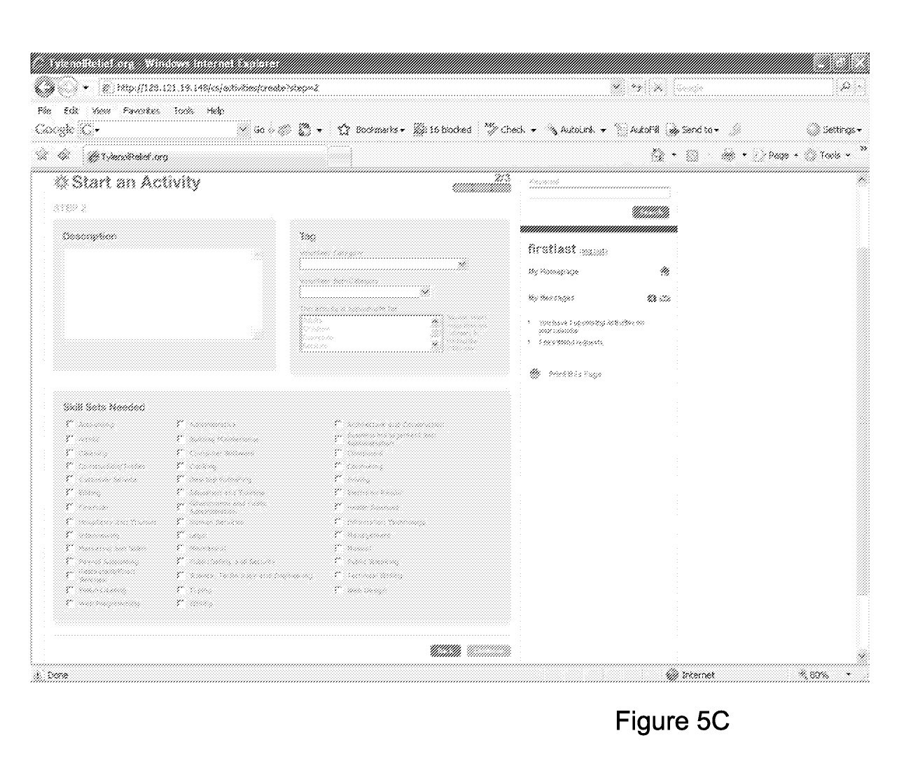

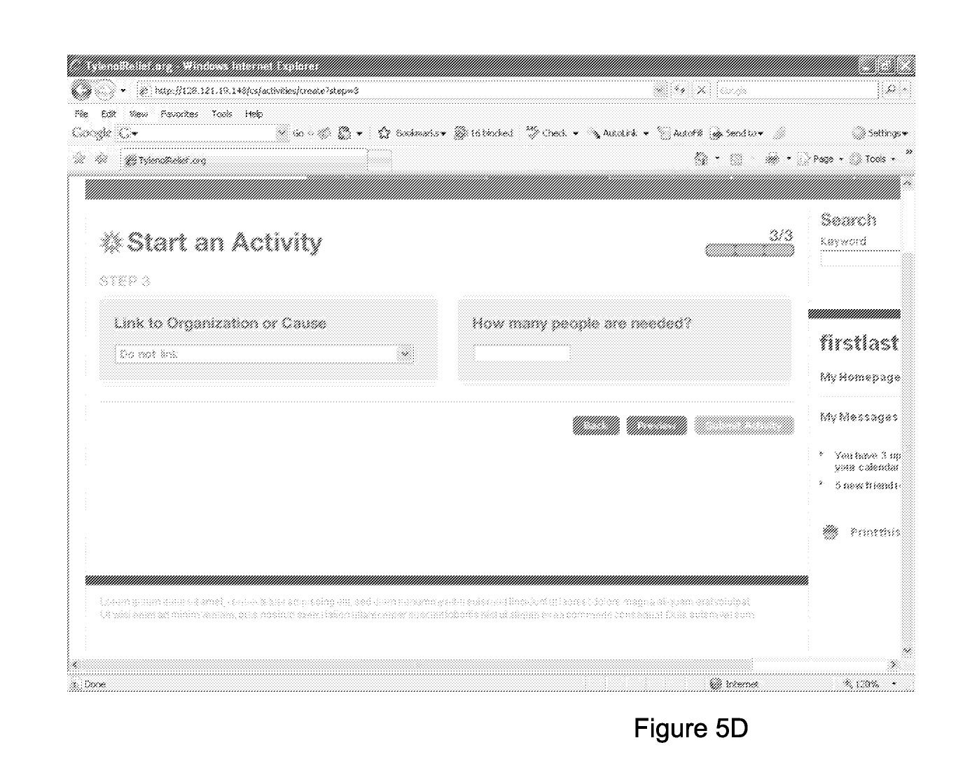

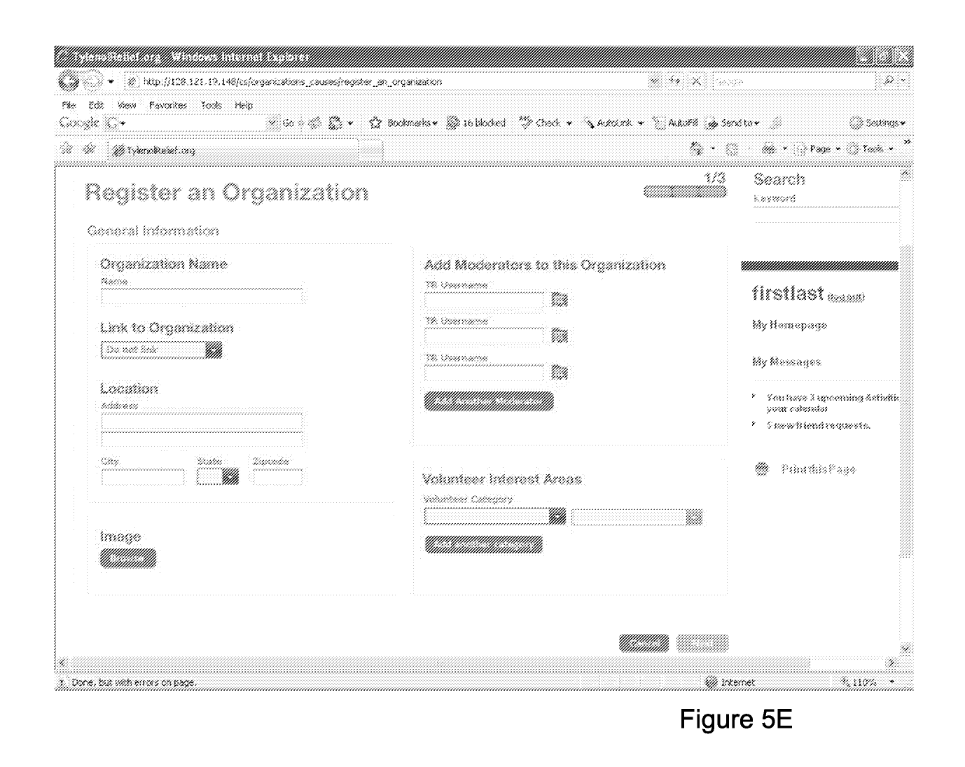

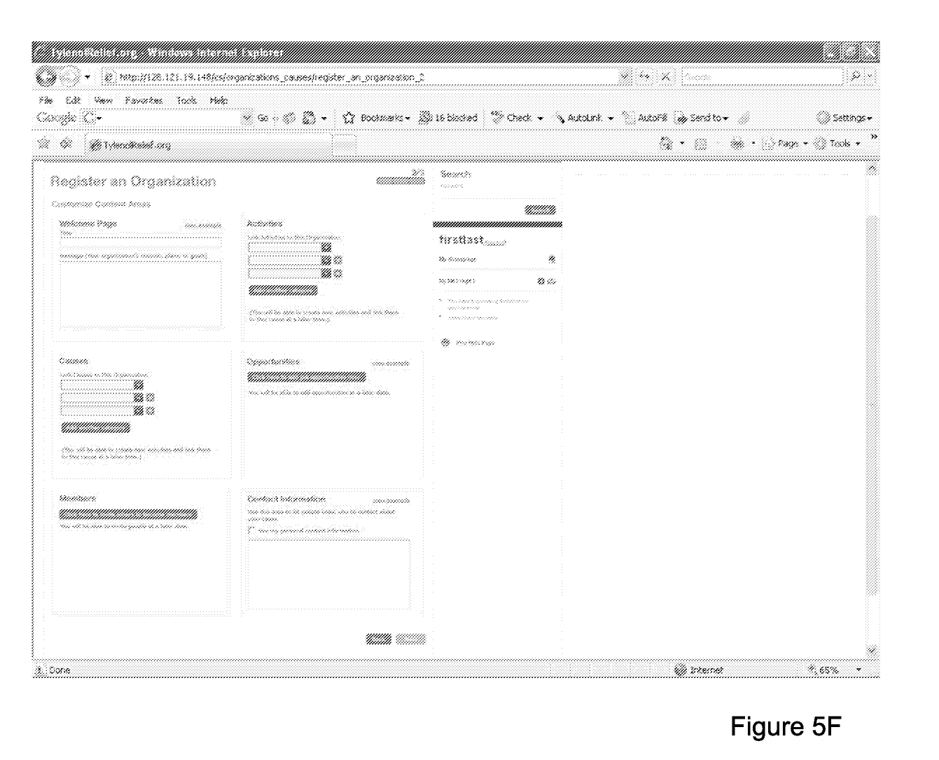

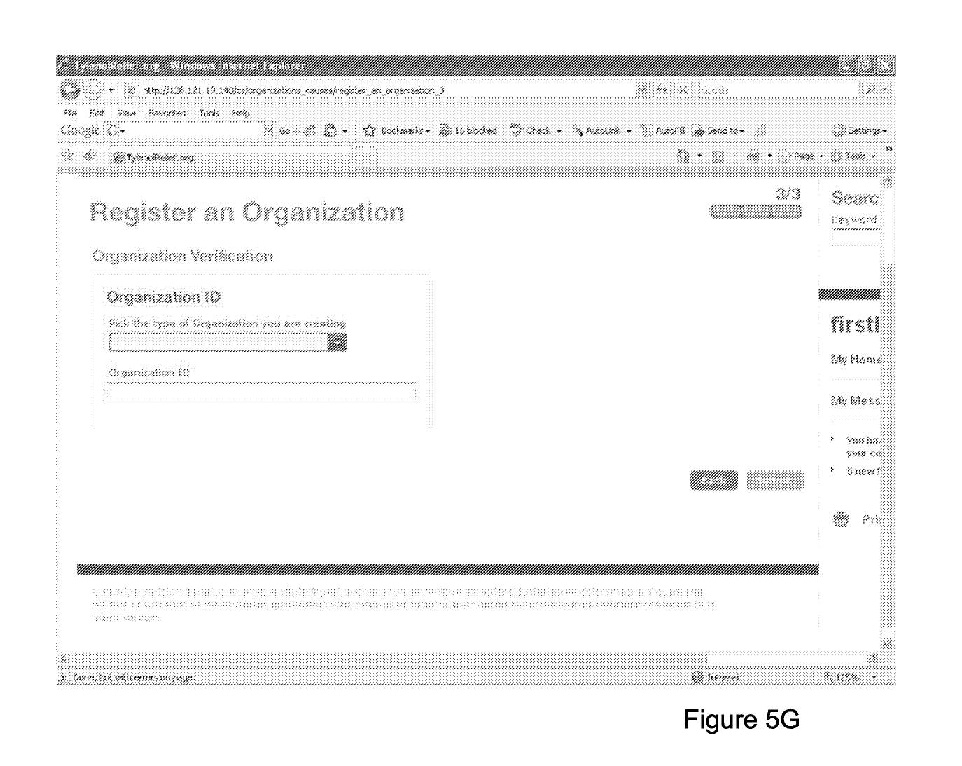

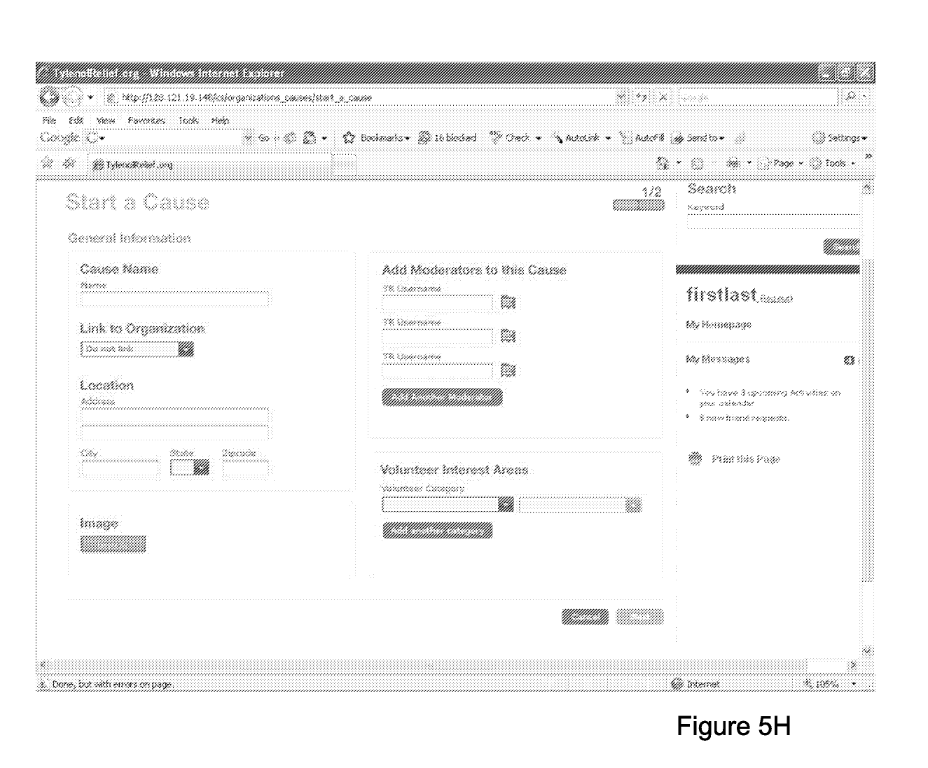

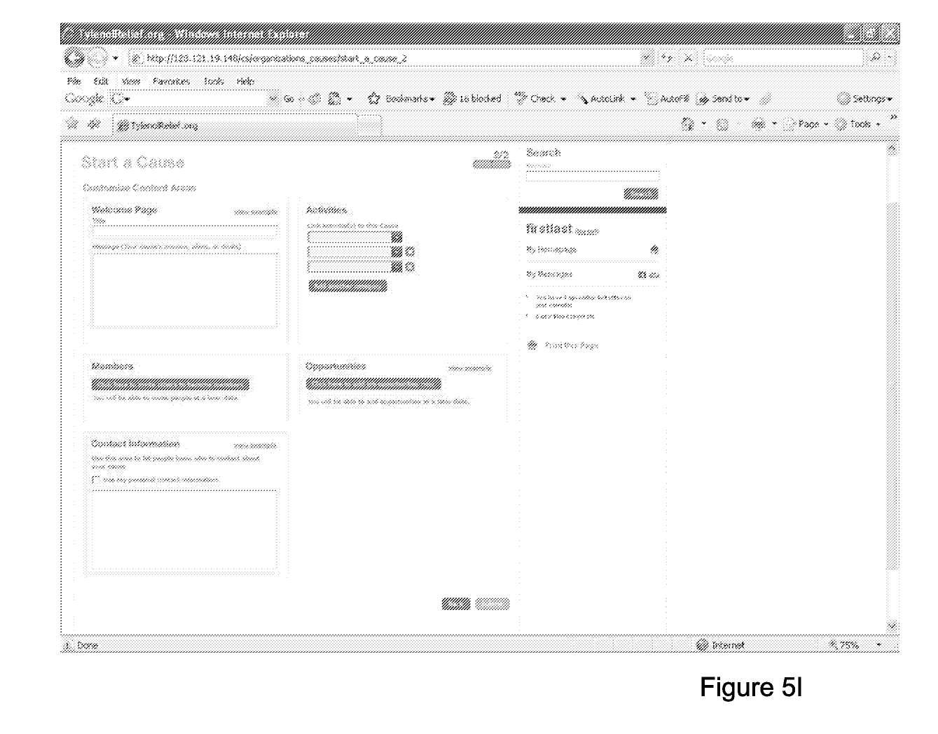

FIG. 5A shows a screenshot for an example interface (implemented on a web page) illustrating features of one embodiment of the Nexus that allows users to access functions of the Nexus, including managing their own profile and to communicating and coordinating with other users. In one implementation, the interface is a homepage, with a Mini Profile section 501 showing selected user profile information for reference. One feature in this section allow a user to add or change image(s) associated with their profile, and the user may click on the Edit Profile button to modify their displayed profile.

The homepage may also have a My Friends section 502 for managing and utilizing a user's network of contacts. The My Friends section shows a list of other registered users who have been identified as friends. This list may display the photo associated with the user profile as well as the screen name of the individual. In addition, it may show if the user has any pending friend requests. There may also be a View All button which, when clicked, will go to a full-page view of all of the user's friends. If the user clicks on the friend requests, they will go to the messaging center where they can chose to accept or decline the friend request

A Messages section 503 provides a preview display of the latest messages the user has received, with an indicator at the top of the section identifying the number of new unread messages the user has. In one embodiment, the Messages section 503 allows a user to compose a new message, view all messages and/or go to a messaging center. For example, if a site visitor clicks on any of the message previews, they may be directed to that full message within the messaging center. In one embodiment, the message center acts as a communication hub allowing users the ability to send and receive messages with other registers users of the Nexus, including functions to compose, reply to, forward, read and delete messages. By providing communication and enabling the coordination of activities, the Nexus helps foster a social community. In one embodiment, the message center is configured to only accept internal messages (i.e., no external emails may be received by the message center). However, in a further embodiment, external emails may be sent out from the message center.

A calendar section 504 displays the current month's calendar, and may highlight dates that have an associated activity. In one implementation, when a user moves their mouse over a highlighted date, a small pop-up display may show brief details about the activity scheduled for that date (e.g., using Ajax functionality). The user can also click on the View Calendar button to go to a full page view of the calendar, allowing a user to make edits to calendar items.

The My Activities section 505 displays a list of activities that the user has created, including the date and a brief description of the activity. A user may also create a new activity and/or click on the View All button to go to an activities management page.

The My Organizations and Causes section 506 display a list of organizations and causes that the user has created. The listing will displays the name and a brief description of the organization or cause. The user may create a new organization or cause and/or they can click on the View All button to go to an interstitial page where they can chose to go to organization or cause management pages.

Create Activity

In some embodiments, the Nexus provides a function and interface that allows registered users to set up an activity, such as a service project, for which people can volunteer and/or organizations can sponsor. In one embodiment where the interface is a webpage, a user, such as an organization, cause or person, that wants to create an activity clicks on the Create an Activity button on their Homepage and fills out a form or forms to register the new activity. Table 4 below details example data elements that may be provided on an activity creation interface allowing a user to create an activity in an embodiment of the Nexus.

TABLE 4
Create Activity Data Elements

| | Form | Form | | | Database | | |
|---|---|---|---|---|---|---|---|
| | Input | Field | Database | Database | Field | | |
| Form Label | Type | Size | Name | Data Type | Size | Values | Required? |
| Activity | Text | 20 | a_name | varchar | 40 | | Yes |
| Name | Box | | | | | | |
| Address | Text | 20 | a_address1 | varchar | 40 | | Yes |
| | Box | | | | | | |
| Address 2 | Text | 20 | a_address2 | varchar | 40 | | No |
| (label not | Box | | | | | | |
| displayed on | | | | | | | |
| form) | | | | | | | |
| City | Text | 20 | a_city | varchar | 40 | | Yes |
| | Box | | | | | | |
| State | Drop | | a_state | char | 2 | Please Select | Yes |
| | Down | | | | | (null in DB) | |
| | Box | | | | | and All 2 letter | |
| | | | | | | state codes | |
| Zip Code | Text | 10 | a_zip | varchar | 10 | | Yes |
| | Box | | | | | | |
| Activity | File | | a_photo | varchar | 80 | (file reference) | No |
| Photo | | | | | | | |
| Use My | Check | | n/a | n/a | n/a | n/a | No |
| Contact Info | Box | | | | | | |
| Email | Text | 20 | a_email | varchar | 40 | | Yes |
| Address | Box | | | | | | |
| Phone | Text | 10 | a_phone | varchar | 10 | | No |
| Number | Box | | | | | | |
| Start Time | Drop | | a_start_time | datetime | | Numbers from | No |
| Hour | Down | | | | | 1-12 | |
| | Box | | | | | | |
| Start Time | Drop | | a_start_time | datetime | | 0 or 30 | No |
| Minutes | Down | | | | | | |
| | Box | | | | | | |
| Start Time | Drop | | a_start_time | datetime | | AM or PM | No |
| AM/PM | Down | | | | | | |
| | Box | | | | | | |
| End Time | Drop | | a_end_time | datetime | | Numbers from | No |
| Hour | Down | | | | | 1-12 | |
| | Box | | | | | | |
| End Time | Drop | | a_end_time | datetime | | 0 or 30 | No |
| Minutes | Down | | | | | | |
| | Box | | | | | | |
| End Time | Drop | | a_end_time | datetime | | AM or PM | No |
| AM/PM | Down | | | | | | |
| | Box | | | | | | |
| Repeats | Drop | | a_repeats | char | 2 | Does not | No |
| | Down | | | | | repeat, daily, | |
| | Box | | | | | weekly, bi- | |
| | | | | | | weekly, | |
| | | | | | | monthly, semi- | |
| | | | | | | annually, | |
| | | | | | | annually | |
| Description | Text | 2048 | a_desc | varchar | 4096 | | Yes |
| | Area | | | | | | |
| Volunteer | Drop | | a_category | varchar | | | Yes |
| Category | Down | | | | | | |
| | Box | | | | | | |
| Category | Text | 20 | a_category_other | varchar | 40 | | No |
| Other | Box | | | | | | |
| Volunteer | Drop | | a_subcategory | varchar | 40 | | No |
| Sub | Down | | | | | | |
| Category | Box | | | | | | |
| Sub | Text | 20 | a_subcategory_other | varchar | 40 | | No |
| Category | Box | | | | | | |
| Other | | | | | | | |
| Appropriate | Selection | | a_appropriate | char | 2 | Please Select, | Yes |
| For | Box | | | | | Everyone, | |
| | | | | | | Children, | |
| | | | | | | Teenagers, | |
| | | | | | | Adults and | |
| | | | | | | Seniors | |
| Skill Sets | Check | | a_skillset | char | 2 | multiple | Yes |
| Needed | Boxes | | | | | | |
| Link to | Drop | | a_link | char | 2 | | No |
| Organization | Down | | | | | | |
| or Cause | Box | | | | | | |
| How many | Text | 20 | a_num_vol | int | | | Yes |
| volunteers? | Box | | | | | | |

FIG. 5B-5D show example screenshots for web pages illustrating features of the activity creation interface in one embodiment of the Nexus. A user will utilize the forms shown to enter the above data for an activity. In addition to the above described fields, in some embodiments, users will be allowed to upload images associated with an activity that are displayed on the activity detail page and search results pages. A similar interface and process that collects similar data may also be provided for organization creation (FIGS. 5E-5G) and cause creation (FIGS. 5H-5I).

Screening

In some embodiments, the Nexus may validate and verify the entities (volunteers, sponsors, charities) that utilize the services of the Nexus. This may be especially useful to avoid fraud and other adverse events. In one embodiment, for example, if the entity is a not-for-profit organization, the Nexus may validate the organization's IRS-required EIN number. In one implementation, the EIN is collected and verified automatically when the organization registers with the Nexus, for example, by requiring the organization to enter the EIN number in a provided field on the user interface and validating the provided number against an EIN database. Alternatively, an organization's EIN number may be validated manually.

Validation and identity verification may also be provided for volunteers. In some embodiments, this screening may be voluntary and/or situational (e.g., certain charities may request volunteers be screened). However, screening may also be required for particular positions (e.g., working with children and/or other vulnerable populations) or in certain locations (as dictated by local laws). Screening may include name based background checking, Social Security Number validation, fingerprint verification and/or the like. In one embodiment, the Nexus may use a third party service to conduct such screening.

In one embodiment, screening or vetting of individual volunteers may be performed for select individuals, such as those who start causes or participate in efforts or causes that necessitate a particular standard, for example, working with children, senior citizens, and/or in a private domain. In another embodiment, vetting may be offered as a service for non-profit organizations who would like to vet their volunteers. A user's vetting status could then be integrated into their Nexus profile, and additional features or an elevated user status cold be provided to these users as incentive.

In a further embodiment, the Nexus may provide functionality that allows users flag or mark content that a particular user considers objectionable. Flagged content could be screened automatically or with manual review. For example, automated screening could remove or hide content if enough users flag the content. In the manual screening embodiment, a flag triggers an automatic alert that is sent to a predetermined reviewer (e.g., website management staff member) who decides whether the content should or should not be removed from the site.

Additional Implementations

In certain embodiments, the Nexus may be utilized by a sponsor for the selection and sponsorship of charities and connection with volunteers. In one embodiment, the Nexus collects and stores information about the other involved parties (i.e., charities and volunteers), such as, for example, each party's charitable issue or issues. Additional information may be collected and stored for each of the parties, and the sponsor may then use the information collected and stored by the Nexus to determine sponsorship, and to match and connect sponsored charities with volunteers having the same or similar charitable issues as well as complementary locations and schedules.

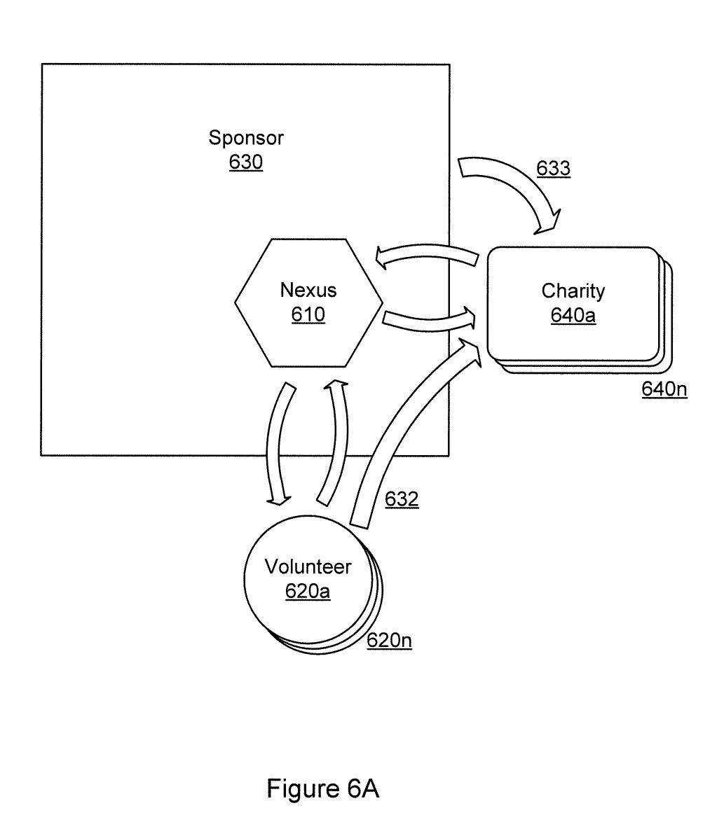

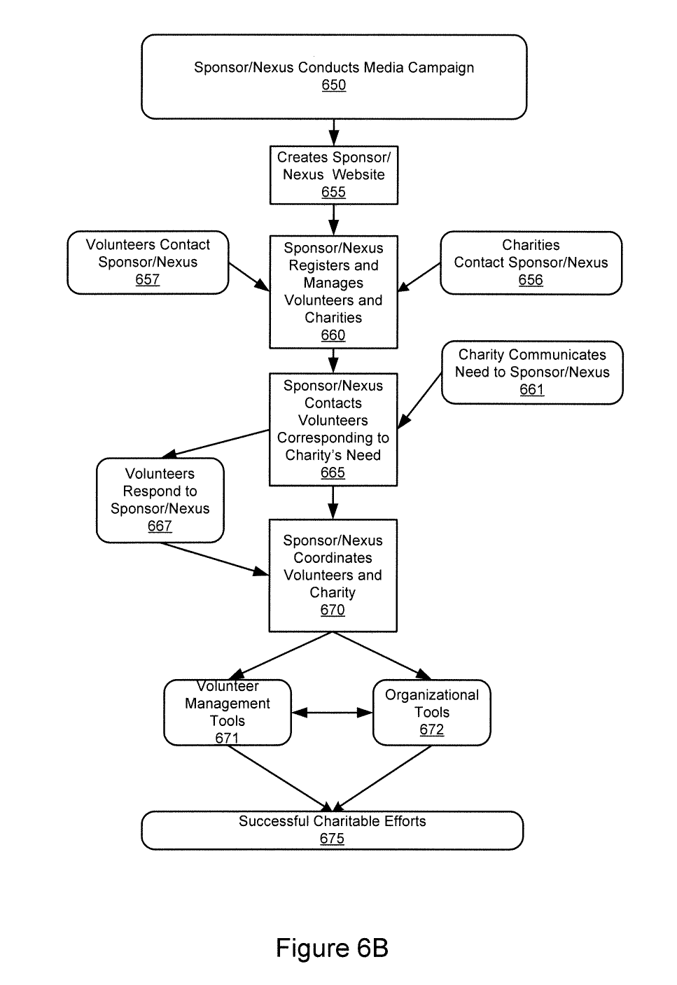

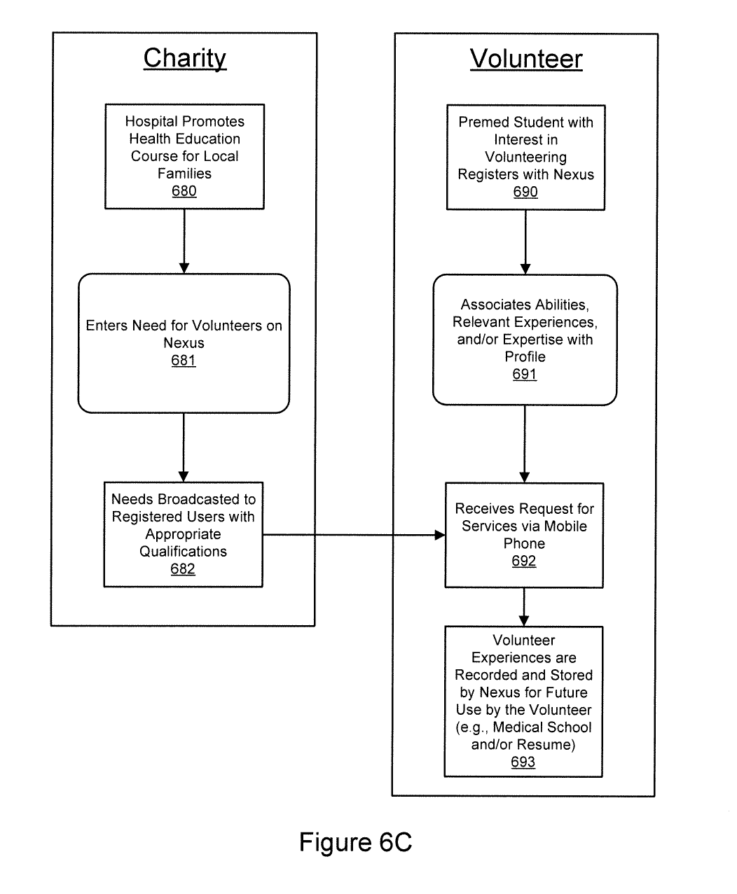

FIG. 6A provides a schematic overview of an embodiment of the Nexus in which a sponsor 630 has an internal Nexus 610. The sponsor 630 implements the Nexus 610 to enable volunteers 620a-620n to connect with charities 640a-640n. In some embodiments, the sponsor 630 may first evaluate and/or determine whether to approve and/or fund 633 certain charities before connecting 632 volunteers 620a-620n to the selected charities 640a-640n. For example, if a charity has a controversial activity planned, the sponsor may choose not to sponsor and/or connect the charity with volunteers. In another embodiment, the sponsor 630 would use information and/or feedback from volunteers in identifying charities 640a-640n to fund 633 and/or connect 632 with volunteers 620a-620n. For example, in one implementation, the Nexus could provide an interface to allow volunteers to nominate and/or vote for selection and/or funding of charities or charitable efforts.

FIG. 6B provides an process flow overview of one implementation of the Nexus. In this embodiment, the sponsor conducts a media campaign 650 and creates a website 655 utilizing user interface aspects of the Nexus. Charities access the website 656, as do volunteers 657, and the Nexus registers and manages the charities and volunteers 660. A particular charity may then communicate a need for volunteers (with certain attributes) to the Nexus 661, and the Nexus contacts volunteers corresponding to the charity's needs 665. Volunteers respond to the Nexus 667, and the sponsor manages the volunteers and charities with the Nexus-provided volunteer management tools 671 and organizational tools 672 to coordinate a successful charitable effort 675.

FIG. 6C provides an process flow overview for an example of a particular implementation of one embodiment of the Nexus. In this embodiment, the charity is a hospital promoting a health education course for local families 680. In this example, one of the volunteers is a premed student who registers with the Nexus 690 and discloses his or her abilities, relevant experiences and/or expertise (as described previously), which is associated with this volunteer's profile 691. When the charity enters their need for volunteers on the Nexus 681 (using the appropriate interfaces disclosed above), the charity's needs are broadcasted to registered users with the appropriate qualifications 682. If the Nexus determines that the premed student meets these qualifications, he or she receives the request for services via mobile phone 692 or similar communication. In some embodiments, if the volunteers performs the service, the Nexus may record and store such experiences for future use by the volunteer 693 (e.g., for use when applying to medical school or for use on a resume).

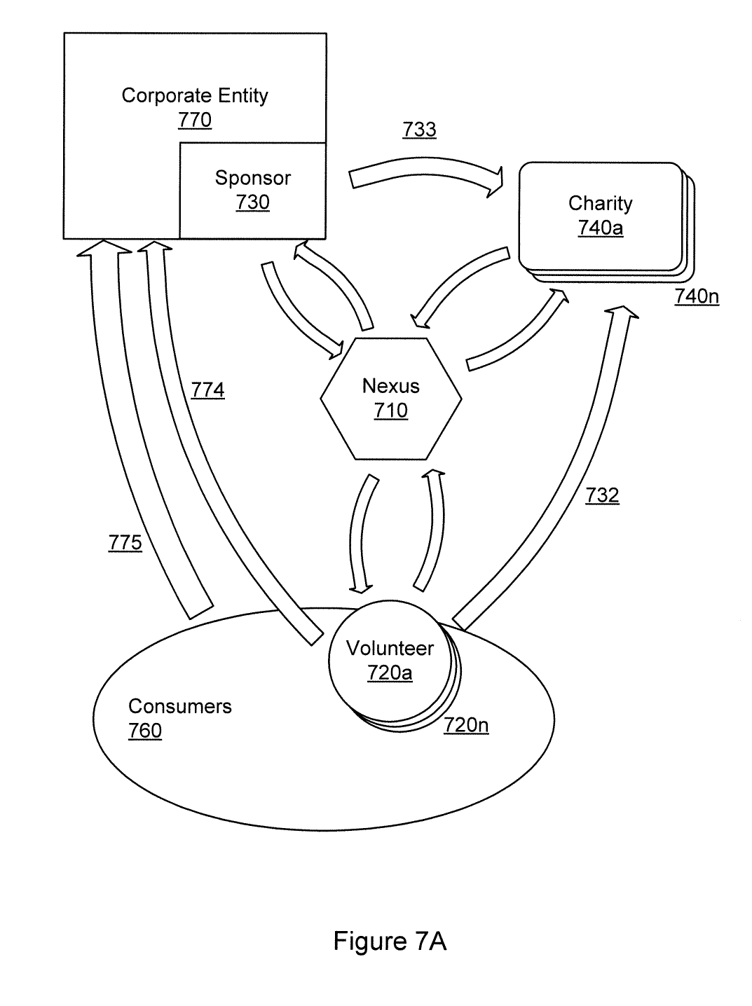

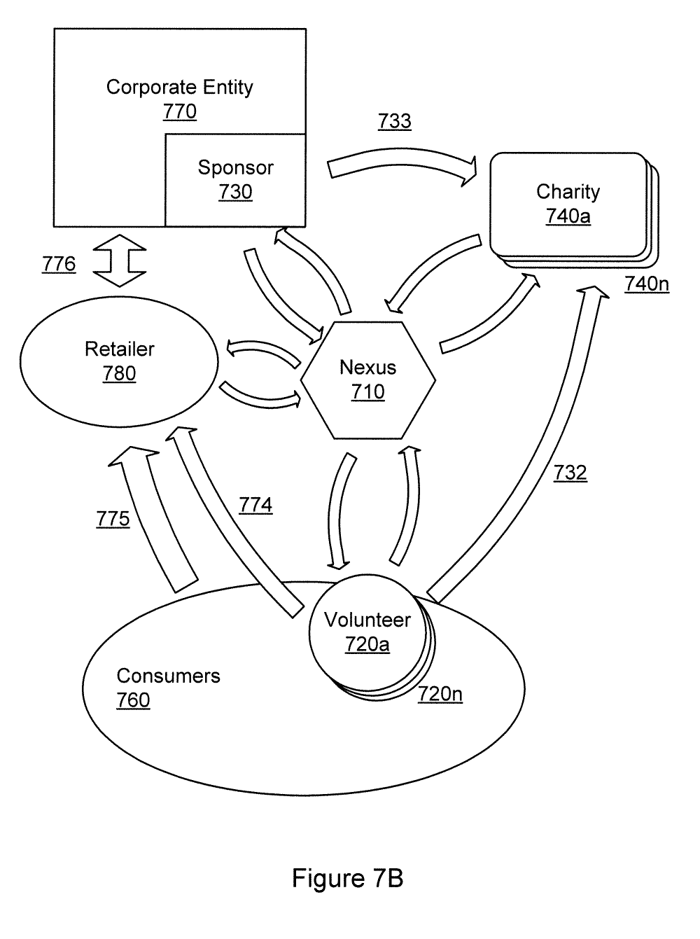

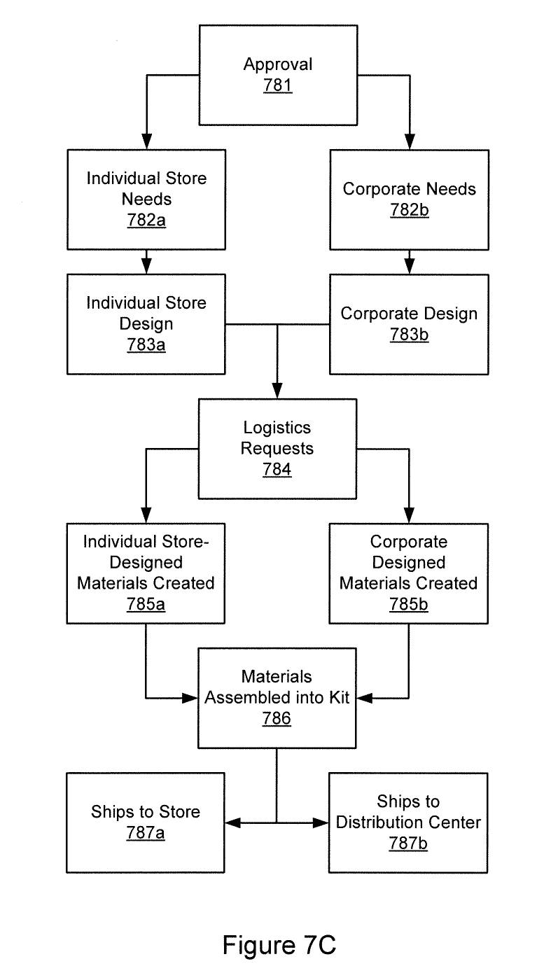

In a further embodiment, a sponsor may use the Nexus in community outreach, publicity and/or advertising campaigns. For example, a corporate sponsor interested in building its philanthropic image among consumers may use the Nexus to identify charities or charitable efforts of interest to particular target groups, such as certain communities or demographic groups of consumers. FIG. 7A provides a schematic overview of an embodiment of the Nexus in which a corporate entity's 770 philanthropic or sponsor group 730 engages the Nexus 710. The corporate entity/sponsor 770/730 uses the Nexus 710 to review charities 740a-740n, and may focus on charities or charitable efforts which are of interest to the particular type or category of volunteers 720a-720n. In a further embodiment, the corporate entity/sponsor may focus on the interests of volunteers thought to be representative of a larger target consumer population 760. The corporate entity/sponsor 770/730 then selects which charity or charities to fund 733. For example, the charitable arm of a company selling children's shoes utilizes the Nexus to identify local charities that support causes that are of interest to parents with young children. For a particular geographic region, the Nexus may indicate that parents of children ages 4-12 volunteer for and utilize a community recreation center. The charitable arm of the company could further utilize the Nexus to identify the center's needs, for example, funding for new track and field equipment, contacting the community recreation center and providing funding.

In some embodiments, the services provided by the Nexus 710 could be implemented to encourage volunteers 720a-720n to further interact 774 with the corporate entity/sponsor 770/730, by providing an incentive for volunteers to purchase the corporate entity's goods and/or services. For example, registered volunteers may get points for purchasing the entity's product (e.g., by entering a code on the product into a website), and may use these points for directing the charitable funding of the company towards a selected charity. In a further embodiment, the services provided by the Nexus 710 could be implemented to encourage consumers 760 to further interact 775 with the corporate entity/sponsor 770/730. Continuing the above example of the company selling children's shoes, by providing sponsorship to the community recreation center, the charitable arm of the company benefits the community and builds the company's reputation within the community, particularly among the local potential consumers (volunteers with children ages 4-12) of the company's product (children's shoes), supporting the company's efforts to attract customers, build loyalty and/or strengthen brand recognition. Additionally, in one implementation, the company could hold a sponsorship drawing where a unique code is in each pair of shoes, and consumers 760 could submit that code on a website to enter the community recreation center (or other charity) in the drawing, where each code entered for a charity increases the chance the charity will be selected for sponsorship.

In another embodiment, the Nexus provides communication between individual consumers, and in a further embodiment, communication between volunteers and consumers. The Nexus may provide, by way of non-limiting example, messages, postings, emails and/or additional communications allowing volunteers to encourage registers volunteers and/or registered consumers, as well as friends and family, to support a particular charity and/or sponsor. In a further implementation, the Nexus may provide communication between consumers and charities. For example, the Nexus may provide consumers with electronic messages or email from particular charities indicating a charity's needs or planned activities, or communicating promotions which may be of interest to the consumers.

In some embodiments of the invention, an additional entity is part of the interaction between a corporate entity and consumers, for example, a retailer that sells a company's product(s) to consumers. FIG. 7B provides a schematic overview of an embodiment of the Nexus in which a retailer 780 or similar entity provides an interface between the corporate entity 770 and consumers 760, for example, via an interne site and/or web page(s). The retailer 780 may utilize the Nexus 710 to communicate with the corporate entity/sponsor 770/730, charities 740a-740n, volunteers 720a-720n and/or consumers 760, for example, via the web interfaces and messaging capabilities discussed in FIGS. 5A-5I. In one embodiment, the corporate entity/sponsor 770/730 utilizes the Nexus 710 to communicate and coordinate with charities 740a-740n, volunteers 720a-720n and consumers 760, as described above, and further to communicate and coordinate with a retailer 780. This communication and coordination may be to support the corporate entity/sponsor's 770/730 objectives, which may include promotions and other publicity directing volunteers 720a-720n and consumers 760 to the retailer and/or the corporate entity/sponsor's 770/730 products or services 776, provided by the retailer, for example, via web promotions and/or in store promotions. The Nexus may be further utilized to customize promotions utilizing information from any or all of the users of the Nexus (e.g., information regarding certain target volunteers and/or consumers gathered by the Nexus, such as charitable interests and demographics).

FIG. 7C provides a schematic overview of an aspect of one embodiment of the Nexus in which a retailer or similar entity and a corporate entity/sponsor utilize the Nexus to customize and generate promotional materials. By doing so, the Nexus may promote a retailer's cause related marketing efforts and help them differentiate from other retailers and/or he viewed as a good corporate citizen The Nexus receives a directive for a particular promotional campaign 781 (e.g., a communication from corporate management) and receives individual store needs 782a and corporate needs 782b (e.g., via a web site where each can disclose their needs). For example, such an embodiment allows customized shippers, brochures, flyers, posters, direct mail and/or the like The Nexus may receive individual store designs 783a and corporate designs 783b (emailed and/or uploaded to the Nexus) and appropriately combines and coordinates the individual store and corporate information and submits a corresponding logistics request 784. The individual store materials 785a and corporate materials 785b are created and assembled into a kit 786 which is shipped to the store 787a and/or distribution center 787b. In one embodiment, such a kit may include flyers and/or in store displays.

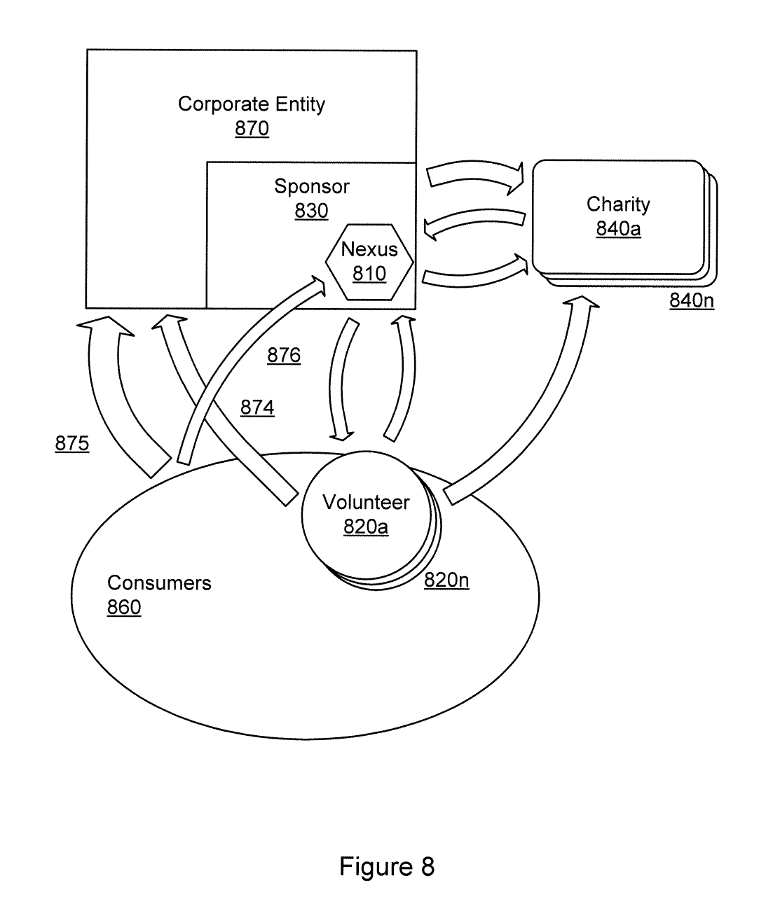

FIG. 8 provides a schematic overview of a further embodiment of the Nexus in which a corporate entity/sponsor 870/830 has an internal Nexus 810. The corporate entity/sponsor 830 enables volunteers 820a-820n to connect with charities 840a-840n. In one embodiment, the internal Nexus 810 allows volunteers 820a-820n who donate time and/or effort 832 to particular charities 840a-840n to direct charitable funding decisions. In certain embodiments, the internal Nexus may interact with external sponsors. In a further embodiment, the internal Nexus provides for communication and coordination among individual volunteers 820a-820n. In certain embodiments the internal Nexus 810 provides a mechanism 876 for consumers 860 to influence the charitable funding decisions of the corporate entity/sponsor 870/830. Using the above example of the company selling children's shoes, the company could use the Nexus to provide a code with each pair of shoes sold, and consumers could contact the Nexus and enter the provided code to support or vote for a certain charity. The company would use the consumer response in making charitable funding decisions. In certain embodiments, the services of the Nexus are provided to increase effectiveness of charitable efforts, build reputation, develop brand image and/or generate good publicity.

### Nexus Controller

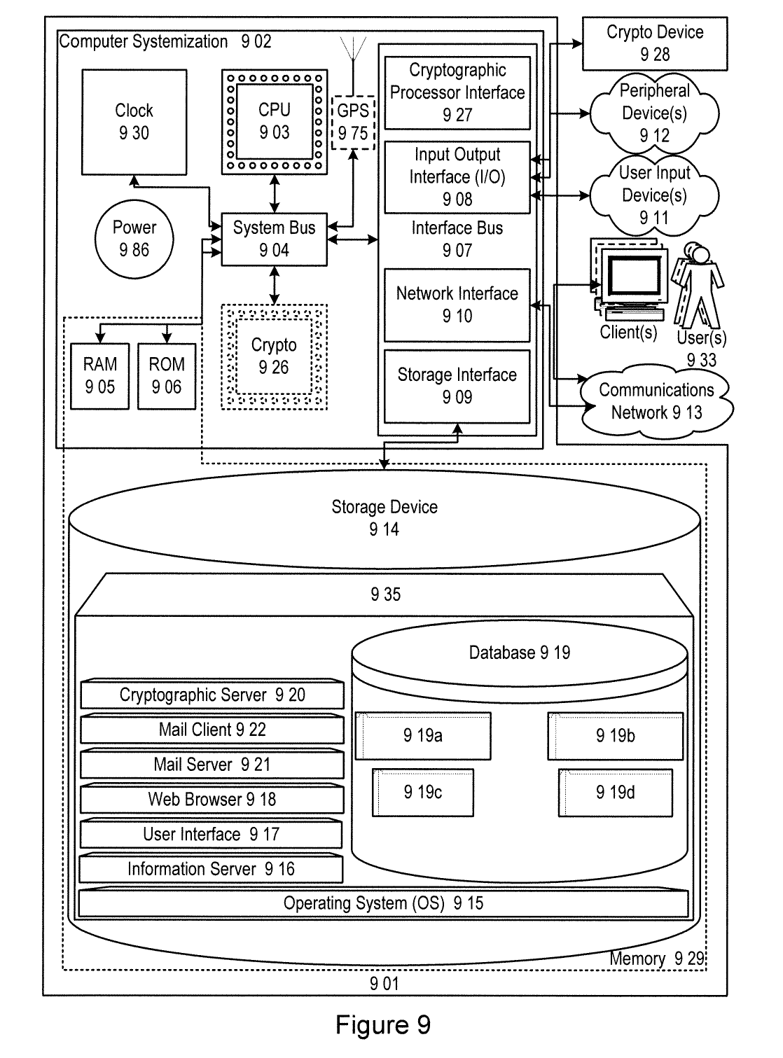

FIG. 9 of the present disclosure illustrates inventive aspects of a Nexus controller 9 01 in a block diagram. In this embodiment, the Nexus controller 9 01 may serve to process, accept, retrieve, store, search, serve, submit, identify, transmit, instruct, generate, match, and/or update databases containing relevant volunteer information, sponsor information and/or charity information and/or related data.

Typically, users, which may b e people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the Nexus controller 9 01 may be connected to and/or communicate with entities such as, but not limited to: one or more users from user input devices 9 11; peripheral devices 9 12; and/or a communications network 9 13.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Nexus controller 9 01 may be based on common computer systems that may comprise, but are not limited to, components such as: a computer systemization 9 02 connected to memory 9 29.

Computer Systemization

A computer systemization 9 02 may comprise a clock 9 30, central processing unit (CPU) 9 03, a read only memory (ROM) 9 06, a random access memory (RAM) 9 05, and/or an interface bus 9 07, and most frequently, although not necessarily, are all interconnected and/or communicating through a system bus 9 04. Optionally, the computer systemization may be connected to an internal power source 9 86. Optionally, a cryptographic processor 9 26 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may he connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC Intel's Celeron, Itanium, Pentium, Xeon, Core and/or XScale; and/or the like processor(s). The CPU interacts with memory through signal passing through conductive conduits to execute stored program code according to conventional data processing techniques. Such signal passing facilitates communication within the Nexus controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 9 86 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 9 86 is connected to at least one of the interconnected subsequent components of the Nexus controller thereby providing an electric current to all subsequent components. In one example, the power source 9 86 is connected to the system bus component 9 04. In an alternative embodiment, an outside power source 9 86 is provided through a connection across the I/O 9 08 interface. For example, a USB and/or IEEE 1394 connection carries both data and power across the connection and is therefore a suitable source of power.

Interface Adapters

Interface bus(ses) 9 07 may accept, connect, and/or communicate to a number of interface adapters, conventionally although not necessarily in the form of adapter cards, such as but not limited to: input output interfaces (I/I) 9 08, storage interfaces 9 09, network interfaces 9 10, and/or the like. Optionally, cryptographic processor interfaces 9 27 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 9 09 may accept, communicate, and/or connect to a number of storage devices such as, but not limited to: storage devices 9 14, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 9 10 may accept, communicate, and/or connect to a communications network 9 13. Through a communications network 9 13, the Nexus controller is accessible through remote clients 9 33b (e.g., computers with web browsers) by users 9 33a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 9 10 may be used to engage with various communications network types 9 13. For example, multiple network interfaces may be employed to allow for the communication over broadcast, multicast, and/or unicast networks.

Input Output interfaces (I/O) 9 08 may accept, communicate, and/or connect to user input devices 9 11, peripheral devices 9 12, cryptographic processor devices 9 28, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 9 11 may be card readers, dongles, finger print readers, gloves, graphics tablets, joysticks, keyboards, mouse (mice), remote controls, retina readers, trackballs, trackpads, and/or the like.

Peripheral devices 9 12 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Nexus controller may be embodied as an embedded, dedicated, and/or monitor-less (i.e., headless) device, wherein access would be provided over a network interface connection.

Memory

Generally, any mechanization and/or embodiment allowing a processor to affect the storage and/or retrieval of information is regarded as memory 9 29. However, memory is a fungible technology and resource, thus, any number of memory embodiments may be employed in lieu of or in concert with one another. It is to be understood that the Nexus controller and/or a computer systemization may employ various forms of memory 9 29. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 9 29 will include ROM 9 06, RAM 9 05, and a storage device 9 14. A storage device 9 14 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 9 29 may contain a collection of program and/or database modules and/or data such as, but not limited to: operating system module(s) 9 15 (operating system); information server module(s) 9 16 (information server); user interface module(s) 9 17 (user interface); Web browser module(s) 9 18 (Web browser); database(s) 9 19; cryptographic server module(s) 9 20 (cryptographic server); the Nexus module(s) 9 35; and/or the like (i.e., collectively a module collection). These modules may be stored and accessed from the storage devices and/or from storage devices accessible through an interface bus. Although non-conventional software modules such as those in the module collection, typically, are stored in a local storage device 9 14, they may also be loaded and/or stored in memory such as: peripheral devices, RAM, remote storage facilities through a communications network, ROM, various forms of memory, and/or the like.

Operating System

The operating system module 9 15 is executable program code facilitating the operation of the Nexus controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the Nexus controller to communicate with other entities through a communications network 9 13. Various communication protocols may be used by the Nexus controller as a subcarrier transport mechanism for interaction, such as, but not limited to: multicast, TCP/IP, UDP, unicast, and/or the like.

Information Server

An information server module 9 16 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective−) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the Nexus controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the Nexus controller, operating systems, other program modules, user interfaces, Web browsers, and/or the like.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 9 17 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 9 18 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Nexus enabled nodes. The combined application may be nugatory on systems employing standard Web browsers.

The Nexus Database

The Nexus database 9 19 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Nexus database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the lead bidding system database is implemented as a data-structure, the use of the Nexus database 9 19 may be integrated into another component such as the Nexus controller module 9 35. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 9 19 includes several tables 9 19a-d. A volunteers table 9 19a includes fields such as, but not limited to: a volunteer's name, contact information, charitable interest(s), availability, volunteer_id, and/or the like. The volunteers table may support and/or track multiple entity accounts on the Nexus. A sponsors table 9 19b includes fields such as, but not limited to: a sponsor's name, contact information, charitable interest(s), available resources, sponsor_id, and/or the like. A charities table 9 19c includes fields such as, but not limited to: a charity's name, contact information, charitable interest(s), projects and services, charity_id, and/or the like. A donations table 9 19d includes fields such as, but not limited to: a donor's name, donor_id, donation history, and/or the like.

In one embodiment, the Nexus database may interact with other database systems. For example, employing a distributed database system, queries and data access by Nexus modules may treat the combination of the Nexus database and integrated data security layer database as a single database entity.

In one embodiment, user programs may contain various user interface primitives, which may serve to update the Nexus. Also, various accounts may require custom database tables depending upon the environments and the types of entities the Nexus may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 9 19a-d. The Nexus may be configured to keep track of various settings, inputs, and parameters via database controllers.

The Nexus database may communicate to and/or with other components in a component collection, including itself, and/or facilities of the like. Most frequently, the Nexus database communicates with the Nexus controller module, other program components, and/or the like. The database may contain, retain, and provide information regarding other nodes and data.

Nexus Controller Module

The Nexus controller module 9 35 is stored program code that is executed by the CPU. The Nexus controller module affects accessing, obtaining and the provision of a Nexus, and/or the like across various communications networks. The Nexus enables volunteers, sponsors and charities to easily identify, connect, and coordinate with one another.

The Nexus controller module enabling access of information between nodes may be developed by employing standard development tools such as, but not limited to: (ANSI) (Objective−) C (++), Apache modules, binary executables, database adapters, Java, JavaScript, mapping tools, procedural and object oriented development tools, PERL, Python, shell scripts, SQL commands, web application server extensions, WebObjects, and/or the like. The Nexus controller module may communicate to and/or with other modules in a module collection, including itself, and/or facilities of the like. Most frequently, the Nexus controller module communicates with the Nexus library, operating systems, other program modules, and/or the like. The Nexus controller module may contain, communicate, generate, obtain, and/or provide program module, system, user, and/or data communications, requests, and/or responses.

Distributed Nexus

The structure and/or operation of any of the Nexus controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the Nexus controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It ill be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1. A method for connecting volunteers, sponsors, and charities, comprising:
collecting entity profile information from an entity, wherein the entity profile information includes:
identifying information, and
charitable interests;
obtaining a request form an interested entity to identify other entities with whom cooperation may occur, the request including desired cooperative criteria;
analyzing the stored profiles to identify similar entities; and
connecting entities with complementary profile information.

2. The method of claim 1 wherein the identifying information includes a name.

3. The method of claim 1 wherein the profile information includes location information.

4. The method of claim 1 wherein the profile information includes schedule and availability information.

5. The method of claim 4 wherein the schedule and availability information includes time schedule information.

6. The method of claim 1 wherein the profile information includes skills/abilities information.

7. The method of claim 1 wherein the profile information includes demographic information.

8. The method of claim 1 wherein the profile information includes contact information.

9. A method for connecting volunteers, sponsors, and charities comprising:
collecting and storing volunteer profile information from each of a plurality of volunteers, wherein volunteer profile information includes:
identifying information,
charitable interests information, and
location information;
collecting and storing sponsor profile information from each of a plurality of sponsors, wherein sponsor profile information includes:
identifying information, and
charitable interests information;
collecting and storing charity profile information from each of a plurality of charities, wherein charity profile information includes:
identifying information,
charitable interests information, and
location information;
analyzing stored profile information to identify similar and complementary profiles; and
connecting volunteers, sponsors and charities with similar and complementary profiles as requested.

10. The method of claim 9 wherein the volunteer profile information includes availability information.

11. The method of claim 10 wherein the availability information includes location information.

12. The method of claim 10 wherein the availability information includes time schedule information.

13. The method of claim 9 wherein the volunteer profile information includes skills/abilities information.

14. The method of claim 9 wherein the volunteer profile information includes demographic information.

15. The method of claim 9 wherein the volunteer profile information includes consumer behavior information.

16. The method of claim 9 wherein the volunteer profile information includes marketing related information.

17. The method of claim 9 wherein the sponsor profile information includes location information.

18. The method of claim 9 wherein the sponsor profile information includes funding information.

19. The method of claim 9 wherein the sponsor profile information includes locations of interest information.

20. The method of claim 9 wherein the sponsor profile information includes demographics of interest information.

21-163. (canceled)
